(19) United States
(12) Patent Application Publication
(10) Pub. No.: US 2012/0245741 A1
(43) Pub. Date: Sep. 27, 2012

(54) INFORMATION PROCESSING APPARATUS, INFORMATION PROCESSING METHOD, RECORDING MEDIUM, AND PROGRAM

(75) Inventor: Makoto Ikushima, Kanagawa (JP)

(73) Assignee: Sony Corporation, Tokyo (JP)

(21) Appl. No.: 13/419,802

(22) Filed: Mar. 14, 2012

(30) Foreign Application Priority Data
Mar. 22, 2011 (JP) 2011-062729

(51) Int. Cl. G05D 7/00

(52) U.S. Cl. 700/282

(57) ABSTRACT

An information processing apparatus includes a plurality of wind pressure sensors that detect wind pressures, and a control unit that controls a predetermined process to be performed according to difference of the wind pressures detected by the plurality of wind pressure sensors.

### BACKGROUND

The present disclosure relates to an information processing apparatus, an information processing method, a recording medium, and a program, and more particularly, to an information processing apparatus, an information processing method, a recording medium, and a program to improve operability.

Currently, in an information processing apparatus such as a mobile phone and a tablet PC (Personal Computer), there are various user interfaces such as buttons, a keyboard, a touch panel, and a mouse.

A technique of using a wind pressure sensor as a user interface is proposed.

For example, Japanese Unexamined Patent Application Publication No. 2004-177992 describes that a process is performed according to whether or not there is an input using a wind pressure sensor of a mobile terminal apparatus provided with the wind pressure sensor or a process is performed according to the intensity of wind pressure and continuation time of wind pressure.

As described above, by using the wind pressure sensor as the user interface, it is possible to operate the mobile terminal apparatus without direct contact of the user to the mobile terminal apparatus.

### SUMMARY

In the disclosure of Japanese Unexamined Patent Application Publication No. 2004-177992, a predetermined process is performed considering wind pressure. However, the process based on the wind pressure is the same as a process according to an operation of, for example, one button. Accordingly, in the disclosure of Japanese Unexamined Patent Application Publication No. 2004-177992, the process which can be performed is limited.

It is desirable to improve operability.

According to an embodiment of the present disclosure, there is provided a mobile terminal apparatus including: a plurality of wind pressure sensors that detect wind pressures; and a control unit that controls a predetermined process to be performed according to difference of the wind pressures detected by the plurality of wind pressure sensors.

The mobile terminal apparatus may further include: a display unit that displays an image; and a calculation unit that calculates an absolute value of the difference of the wind pressures detected by the plurality of wind pressure sensors, wherein the control unit performs the predetermined process on the image displayed on the display unit on the basis of the absolute value calculated by the calculation unit.

In the mobile terminal apparatus, the plurality of wind pressure sensors may include a first wind pressure sensor and a second wind pressure sensor provided at predetermined positions around the display unit, the calculation unit may calculate the absolute value of the difference between a first wind pressure detected by the first wind pressure sensor and a second wind pressure detected by the second wind pressure sensor, and the control unit may control the image of the display unit to be scrolled when the absolute value is equal to or more than a first threshold value, and may control a selection item displayed on the display unit to be selected when the absolute value is less than the first threshold value.

In the mobile terminal apparatus, the control unit may control the image of the display unit to be scrolled in a direction from the first wind pressure sensor to the second wind pressure sensor when the absolute value is equal to or more than the first threshold value and the first wind pressure is higher than the second wind pressure, and the control unit may control the image of the display unit to be scrolled in a direction from the second wind pressure sensor to the first wind pressure sensor when the absolute value is equal to or more than the first threshold value and the first wind pressure is lower than the second wind pressure.

In the mobile terminal apparatus, the control unit may change at least one of the movement amount and the speed of scrolling according to at least one of the first wind pressure and the second wind pressure.

In the mobile terminal apparatus, the control unit may divide the screen of the display unit into a plurality of parts in the direction from the first wind pressure sensor to the second wind pressure sensor, and control the selection item of the division closer to the higher of the first wind pressure and the second wind pressure to be selected when the absolute value is less than the first threshold value and equal to or more than a second threshold value.

In the mobile terminal apparatus, the control unit may control the selection item of the intermediate division between the first wind pressure sensor and the second wind pressure sensor to be selected when the absolute value is less than the first threshold value and less than the second threshold value.

In the mobile terminal apparatus, the first wind pressure sensor may be provided at an upper portion of the display unit, and the second wind pressure sensor may be provided at a lower portion of the display unit.

In the mobile terminal apparatus, the first wind pressure sensor may be provided at a left portion of the display unit, and the second wind pressure sensor may be provided at a right portion of the display unit.

In the mobile terminal apparatus, the calculation unit may calculate magnitude of the wind pressure or the absolute value of a difference in time.

In the mobile terminal apparatus, the plurality of wind pressure sensors may be provided at an upper portion, a lower portion, a left portion, and a right portion of the display device, the calculation unit may calculate the absolute value of the difference between an upper wind pressure detected by an upper wind pressure sensor and a lower wind pressure detected by a lower wind pressure sensor, and may calculate the absolute value of the difference between a left wind pressure detected by a left wind pressure sensor and a right wind pressure detected by a right wind pressure sensor, the control unit may control the image of the display unit to be scrolled when the absolute value of the difference between the upper wind pressure and the lower wind pressure is equal to or more than a first threshold value or when the absolute value of the difference between the left wind pressure and the right wind pressure is equal to or more than a second threshold value, and the control unit may control a selection item displayed on the display unit to be selected when the absolute value of the difference between the upper wind pressure and the lower wind pressure is less than the first threshold value and when the absolute value of the difference between the left wind pressure and the right wind pressure is less than the second threshold value.

In the mobile terminal apparatus, the control unit may control the image of the display unit to be scrolled in a downward right direction when the absolute value of the difference between the upper wind pressure and the lower wind pressure is equal to or more than the first threshold value, when the upper wind pressure is higher than the lower wind pressure, when the absolute value of the difference between the left wind pressure and the right wind pressure is equal to or more than the second threshold value, and when the left wind pressure is higher than the right wind pressure, the control unit may control the image of the display unit to be scrolled in a downward left direction when the absolute value of the difference between the upper wind pressure and the lower wind pressure is equal to or more than the first threshold value, when the upper wind pressure is higher than the lower wind pressure, when the absolute value of the difference between the left wind pressure and the right wind pressure is equal to or more than the second threshold value, and when the left wind pressure is lower than the right wind pressure, the control unit may control the image of the display unit to be scrolled in a downward direction when the absolute value of the difference between the upper wind pressure and the lower wind pressure is equal to or more than the first threshold value, when the upper wind pressure is higher than the lower wind pressure, and when the absolute value of the difference between the left wind pressure and the right wind pressure is less than the second threshold value, the control unit may control the image of the display unit to be scrolled in an upward right direction when the absolute value of the difference between the upper wind pressure and the lower wind pressure is equal to or more than the first threshold value, when the upper wind pressure is lower than the lower wind pressure, when the absolute value of the difference between the left wind pressure and the right wind pressure is equal to or more than the second threshold value, and when the left wind pressure is higher than the right wind pressure, the control unit may control the image of the display unit to be scrolled in an upward left direction when the absolute value of the difference between the upper wind pressure and the lower wind pressure is equal to or more than the first threshold value, when the upper wind pressure is lower than the lower wind pressure, when the absolute value of the difference between the left wind pressure and the right wind pressure is equal to or more than the second threshold value, and when the left wind pressure is lower than the right wind pressure, the control unit may control the image of the display unit to be scrolled in an upward direction when the absolute value of the difference between the upper wind pressure and the lower wind pressure is equal to or more than the first threshold value, when the upper wind pressure is lower than the lower wind pressure, and when the absolute value of the difference between the left wind pressure and the right wind pressure is less than the second threshold value, the control unit may control the image of the display unit to be scrolled in a rightward direction when the absolute value of the difference between the upper wind pressure and the lower wind pressure is less than the first threshold value, when the absolute value of the difference between the left wind pressure and the right wind pressure is equal to or more than the second threshold value, and when the left wind pressure is higher than the right wind pressure, and the control unit may control the image of the display unit to be scrolled in a leftward direction when the absolute value of the difference between the upper wind pressure and the lower wind pressure is less than the first threshold value, when the absolute value of the difference between the left wind pressure and the right wind pressure is equal to or more than the second threshold value, and when the left wind pressure is lower than the right wind pressure.

In the mobile terminal apparatus, the control unit may change at least one of the movement amount and the speed of scrolling according to at least one of the upper wind pressure, the lower wind pressure, the left wind pressure, and the right wind pressure.

In the mobile terminal apparatus, the control unit may divide the screen of the display unit into a plurality of parts in the up and down direction and the left and rightward direction, and may control the selection item of the division closer to higher one of the upper wind pressure and the lower wind pressure and closer to higher one of the left wind pressure and the right wind pressure to be selected when the absolute value of the difference between the upper wind pressure and the lower wind pressure is less than the first threshold value and equal to or more than a third threshold value and when the absolute value of the difference between the left wind pressure and the right wind pressure is less than the second threshold value and equal to or more than a fourth threshold value.

In the mobile terminal apparatus, the control unit may control the selection item of the intermediate division between the upper wind pressure sensor and the lower wind pressure sensor to be selected when the absolute value of the difference between upper wind pressure and the lower wind pressure is less than the first threshold value and less than the third threshold value and when the absolute value of the difference between the left wind pressure and the right wind pressure is less than the second threshold value.

In the mobile terminal apparatus, the control unit may control the selection item of the intermediate division between the left wind pressure sensor and the right wind pressure sensor to be selected when the absolute value of the difference between the upper wind pressure and the lower wind pressure is less than the first threshold value and when the absolute value of the difference between the left wind pressure and the right wind pressure is less than the second threshold value and less than the fourth threshold value.

According to another embodiment of the present disclosure, there is provided an information processing method including: controlling a predetermined process to be performed according to difference of wind pressures detected by the plurality of wind pressure sensors.

According to still another embodiment of the present disclosure, there is provided a computer readable recording medium of recording a program for causing a computer controlling an information processing apparatus provided with a plurality of wind pressure sensors detecting wind pressures to execute: controlling a predetermined process to be performed according to difference of wind pressures detected by the plurality of wind pressure sensors, or a program thereof.

In the embodiment of the present disclosure, the predetermined process is performed according to the difference of the wind pressures detected by the plurality of wind pressure sensors.

According to the embodiment of the present disclosure, it is possible to improve operability.

### BRIEF DESCRIPTION OF THE DRAWINGS

FIG. 1 is a diagram illustrating a mobile terminal apparatus according to an embodiment of the present disclosure.

FIG. 2 is a block diagram illustrating a configuration of the mobile terminal apparatus according to the embodiment.

FIG. 3 is a flowchart illustrating a wind pressure control process.

FIG. 4 is a diagram illustrating an example of wind pressure detection.

FIG. 5A and FIG. 5B are diagrams illustrating examples of an output screen.

FIG. 6 is a diagram illustrating an example of wind pressure detection.

FIG. 7 is a diagram illustrating an example of wind pressure detection.

FIG. 8A and FIG. 8B are diagrams illustrating examples of an output screen.

FIG. 9 is a diagram illustrating an example of item selection.

FIG. 10 is a flowchart illustrating an item selecting process.

FIG. 11 is a diagram illustrating an example of wind pressure detection.

FIG. 12 is a diagram illustrating an example of wind pressure detection.

FIG. 13 is a diagram illustrating an example of wind pressure detection.

FIG. 14 is a diagram illustrating an example of an output screen.

FIG. 15 is a diagram illustrating an example of an output screen.

FIG. 16 is a diagram illustrating a mobile terminal apparatus according to an embodiment of the present disclosure.

FIG. 17 is a flowchart illustrating a wind pressure control process.

FIG. 18 is a diagram illustrating an example of wind pressure detection.

FIG. 19A and FIG. 19B are diagrams illustrating examples of an output screen.

FIG. 20 is a diagram illustrating an example of wind pressure detection.

FIG. 21 is a diagram illustrating a mobile terminal apparatus according to an embodiment of the present disclosure.

FIG. 22 is a block diagram illustrating a configuration the mobile terminal apparatus according to the embodiment.

FIG. 23 is a flowchart illustrating a wind pressure control process.

FIG. 24 is a flowchart illustrating a wind pressure control process.

FIG. 25 is a diagram illustrating an example of wind pressure detection.

FIG. 26 is a diagram illustrating an example of the movement amount of scrolling.

FIG. 27A and FIG. 27B are diagrams illustrating examples of an output screen.

FIG. 28 is a diagram illustrating an example of item selection.

FIG. 29 is a flowchart illustrating an item selecting process.

FIG. 30 is a flowchart illustrating an item selecting process.

### DETAILED DESCRIPTION OF EMBODIMENTS

Hereinafter, embodiments of the present disclosure (hereinafter, referred to as the embodiment) will be described. The description is performed in the following order.

### (1) First Embodiment

1. Configuration of Mobile Terminal Apparatus 1

2. Wind Pressure Control Process of Mobile Terminal Apparatus 1

3. Item Selecting Process of Mobile Terminal Apparatus 1

4. Configuration of Mobile Terminal Apparatus 201

5. Wind Pressure Control Process of Mobile Terminal Apparatus 201

### (2) Second Embodiment

6. Configuration of Mobile Terminal Apparatus 301

7. Wind Pressure Control Process of Mobile Terminal Apparatus 301

8. Item Selecting Process of Mobile Terminal Apparatus 301

9. Others

### First Embodiment

### Configuration of Mobile Terminal Apparatus 1

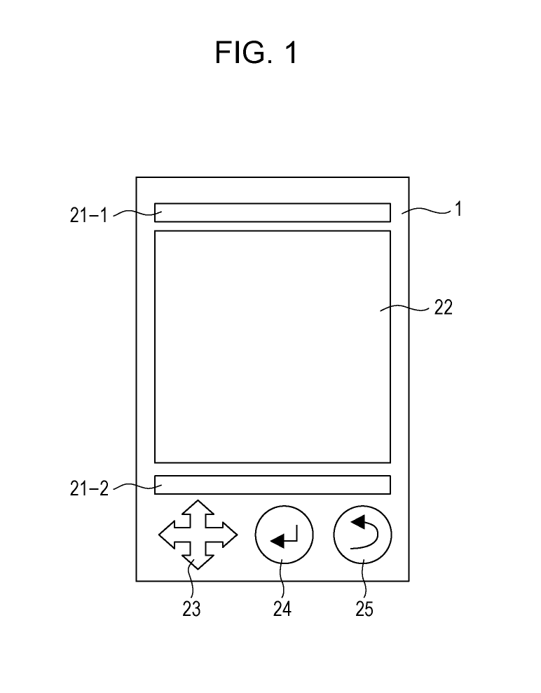

FIG. 1 is a diagram illustrating a mobile terminal apparatus 1 as an information processing apparatus according to an embodiment of the present disclosure. The mobile terminal apparatus 1 shown in FIG. 1 has wind pressure sensors 21-1, 21-2, a display device 22, a cross key 23, an enter button 24, and a back button 25.

When it is not necessary to individually discriminate the wind pressure sensors 21-1 and 21-2, they will simply be described as a wind pressure sensor 21. The same applies to other constituent elements.

The wind pressure sensor 21 detects a pressure based on flow of air, that is, magnitude of a wind pressure, and outputs a wind pressure value based thereon. In the example shown in FIG. 1, the wind pressure sensor 21-1 is provided at the upper portion of the display device 22, and the wind pressure sensor 21-2 is provided at the lower portion of the display device 22.

The display device 22 is configured by, for example, a display for displaying an image. The cross key 23 has, for example, a function of moving a cursor or the like by an operation of a user.

The enter button 24 has, for example, a function of selecting an item indicated by the cursor when it is operated by the user. The back button 25 has, for example, a function of returning a predetermined state to a previous state and a function of canceling a predetermined process by an operation of the user.

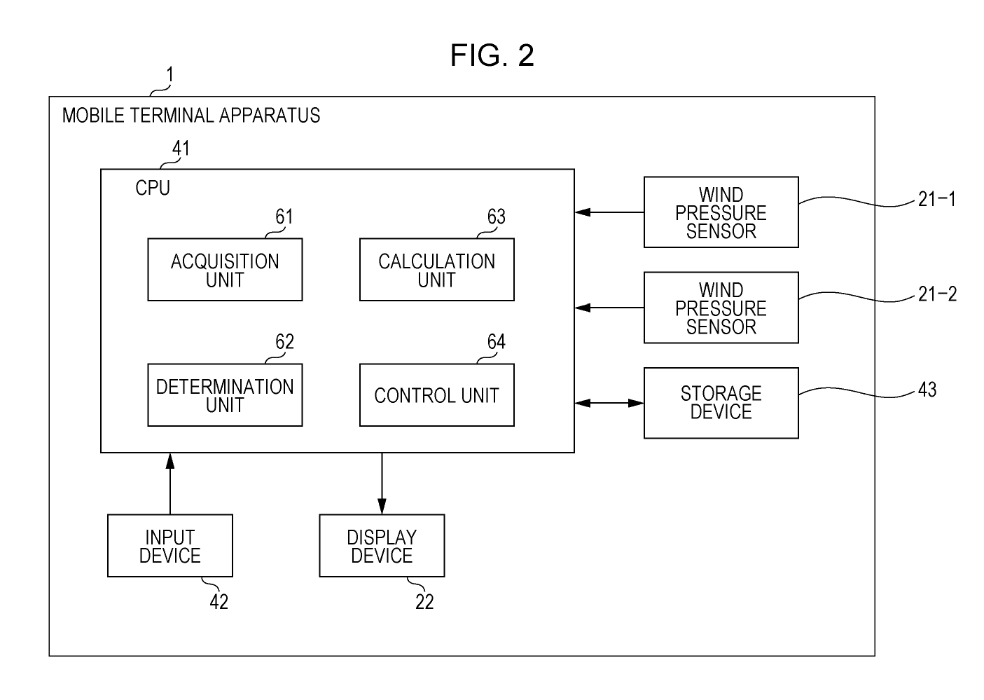

FIG. 2 is a block diagram illustrating a configuration of the mobile terminal apparatus 1 according to the embodiment. The mobile terminal apparatus 1 includes the wind pressure sensors 21-1 and 21-2, the display device 22, a CPU (Central Processing Unit) 41, an input device 42, and a storage device 43.

The CPU 41 includes functional blocks of an acquisition unit 61, a determination unit 62, a calculation unit 63, and a control unit 64. The blocks of the CPU 41 may transmit and receive signals and data to and from each other as necessary.

The acquisition unit 61 acquires various kinds of information. The determination unit 62 determines various kinds of information. The calculation unit 63 performs a predetermined calculation process. The control unit 64 controls various kinds of information.

The input device 42 includes the cross key 23, the enter button 24, and the back button 25 shown in FIG. 1, and may further include a user interface such as a camera, a keyboard, and a mouse, which are operated to input predetermined information by a user.

The storage device 43 is configured by, for example, a hard disk drive and a nonvolatile memory. The storage device 43 stores various process programs performed in the mobile terminal apparatus 1 and data necessary for processes.

[Wind Pressure Control Process of Mobile Terminal Apparatus 1]

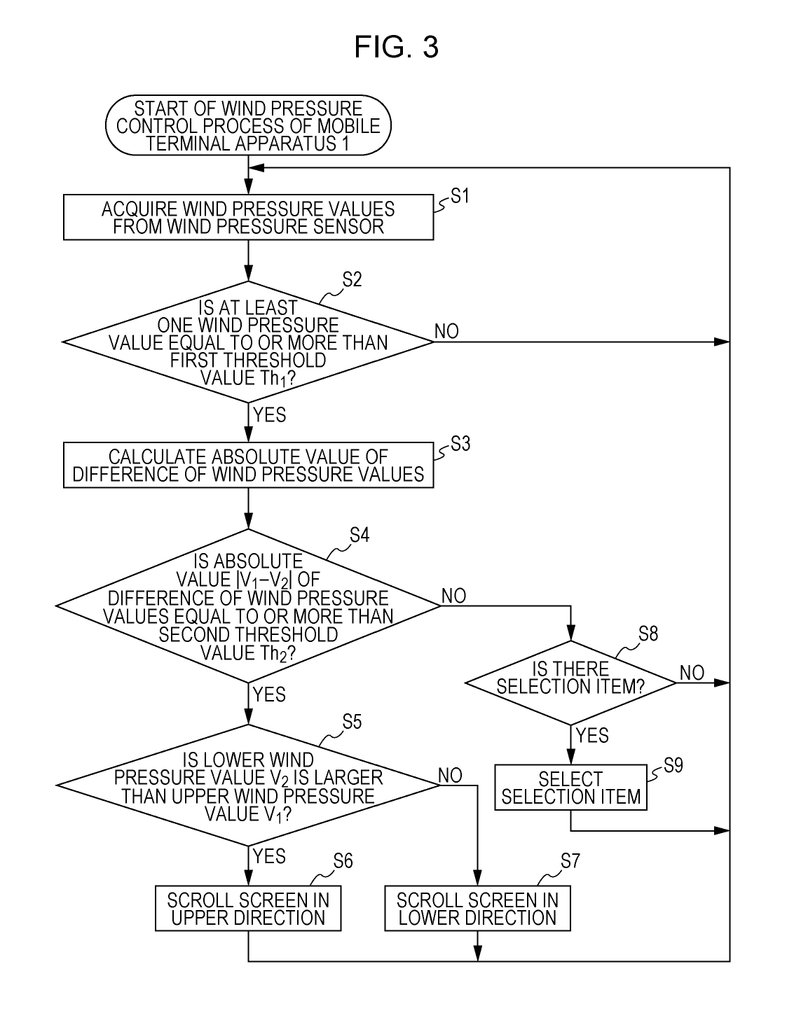

A wind pressure control process of the mobile terminal apparatus 1 will be described with reference to FIG. 3 to FIG. 15.

FIG. 3 is a flowchart illustrating the wind pressure control process of the mobile terminal apparatus 1. The wind pressure control process is performed when the wind pressure sensor 21 detects wind pressure.

In Step S1, the acquisition unit 61 acquires a wind pressure value from the wind pressure sensor 21. That is, an upper wind pressure value V₁ is acquired from the upper wind pressure sensor 21-1 of the mobile terminal apparatus 1, and a lower wind pressure value V₂ is acquired from the lower wind pressure sensor 21-2.

In Step S2, the determination unit 62 determines whether or not at least one wind pressure value is equal to or more than a first threshold value Th₁. That is, at least one of the acquired upper wind pressure value V₁ and the lower wind pressure value V₂ is equal to or more than the first threshold value Th₁.

The first threshold value Th₁ is set in advance to prevent an erroneous operation from occurring due to a wind pressure which is not intended by the user. That is, by the process of Step S2, it is determined whether or not the user blows on the mobile terminal apparatus 1.

In Step S2, when it is determined that at least one wind pressure value is equal to or more than the first threshold value Th₁, that is, when it is determined that the user blows on the mobile terminal apparatus 1, the process proceeds to Step S3.

In Step S3, the calculation unit 63 calculates the absolute value of the difference between the wind pressure values. That is, the absolute value |V₁−V₂| of the difference between the upper wind pressure value V₁ and the lower wind pressure value V₂ is calculated.

In Step S4, the determination unit 62 determines whether or not the absolute value |V₁−V₂| of the difference between the wind pressure values is equal to or more than a second threshold value Th₂. That is, it is determined whether or not |V₁−V₂|≧Th₂.

The second threshold value Th₂ is a threshold value set to determine whether or not the user blows on the inside between the upper wind pressure sensor 21-1 and the lower wind pressure sensor 21-2, that is, onto the display device 22.

That is, by the process of Step S4, it is determined whether the operation of the user is a scrolling operation or an item selecting operation.

In the scrolling operation, the screen displayed on the display device 22 is scrolled in a predetermined direction. In the item selecting operation, a predetermined selection item is selected according to an operation of pressing the enter button 24 shown in FIG. 1 or an operation of clicking the mouse.

In Step S4 shown in FIG. 3, when it is determined that the absolute value |V₁−V₂| of the difference between the wind pressure values is equal to or more than the second threshold value Th₂, that is, when it is determined that the operation of the user is the scrolling operation, the process proceeds to Step S5.

In Step S5, the determination unit 62 determines whether or not the lower wind pressure value V₂ is more than the upper wind pressure value V₁. That is, it is determined whether the direction in which the user blows is from the lower portion or from the upper portion of the mobile terminal apparatus 1.

In Step S5, when it is determined that the lower wind pressure value V₂ is more than the upper wind pressure value V₂ (V₂>V₁), that is, when the user blows from the lower portion of the mobile terminal apparatus 1, the process proceeds to Step S6.

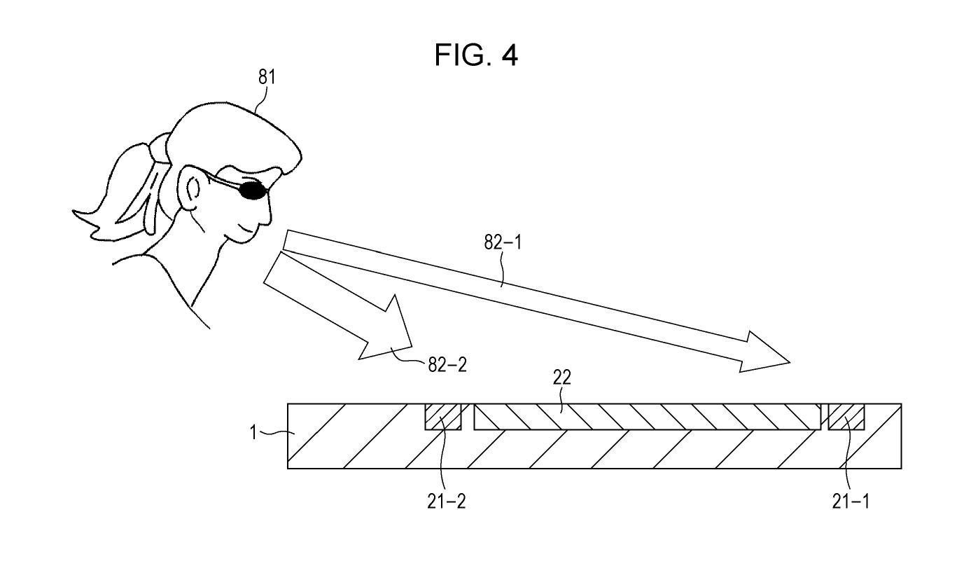

An example when the user blows from the lower portion of the mobile terminal apparatus 1 is shown in FIG. 4.

FIG. 4 is a diagram illustrating an example when the user 81 blows from the lower portion of the mobile terminal apparatus 1. In the example shown in FIG. 4, a side view of the mobile terminal apparatus 1 is shown, and only the wind pressure sensors 21 and the display device 22 are shown for simplification.

In the example shown in FIG. 4, intensities of the wind pressures 82 detected by the wind pressure sensors 21 are represented by thicknesses of arrows of the wind pressures 82. That is, the wind pressure 82 gets higher as the thickness of the arrow of the wind pressure 82 gets thicker, and the wind pressure 82 gets lower as the thickness of the arrow of the wind pressure 82 gets thinner. The same is applied to the other figures.

In the example shown in FIG. 4, the wind pressure 82-2 detected by the wind pressure sensor 21-2 is represented thicker than the wind pressure 82-1 detected by the wind pressure sensor 21-1.

That is, the wind pressure 82-2 detected by the wind pressure sensor 21-2 close to the user 81 is higher than the wind pressure 82-1 detected by the wind pressure sensor 21-1 far from the user 81, and thus the mobile terminal apparatus 1 recognizes that the user 81 blows from the lower portion to the upper portion of the mobile terminal apparatus 1.

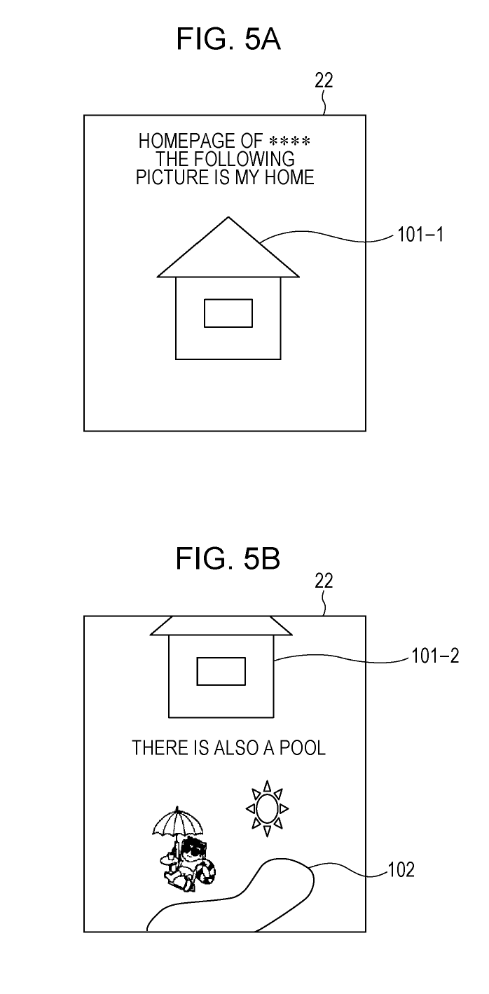

Returning to FIG. 3, in Step S6, the control unit 64 scrolls the screen in the upward direction. That is, the screen is moved in the same direction as the direction in which the user blows. An example of scrolling the screen in the upward direction is shown in FIG. 5.

FIG. 5A and FIG. 5B are diagrams illustrating an example of displaying an arbitrary homepage on the display device 22.

FIG. 5A shows an example of displaying a home 101-1 on the display device 22. FIG. 5B shows an example of displaying a home 101-2 and a pool 102 on the display device 22.

In the state of FIG. 5A, when the user blows from the lower portion of the mobile terminal apparatus 1 and the screen scrolls in the upward direction, the screen of FIG. 5B is displayed on the display device 22.

That is, the display position of the home 101-1 shown in FIG. 5A is moved from the center upwards, and becomes a display position of the home 101-2 shown in FIG. 5B.

The pool 102 which is present under the home 101-1 shown in FIG. 5A and is not shown on the screen of the display device 22 is displayed under the home 101-2 as shown in FIG. 5B.

As described above, the mobile terminal apparatus 1 performs the same process as the process of scrolling the screen using the mouse, the cross key, or the like, on the basis of the wind pressure value acquired from the wind pressure sensor 21.

The control unit 64 may change the movement amount and speed of scrolling according to the wind pressure value.

For example, when the screen of the display device 22 is scrolled in the upward direction as shown in the example of FIG. 5A and FIG. 5B, the screen may be moved more drastically and rapidly in the upward direction as the lower wind pressure value V₂ gets higher and may be moved more slightly and slowly in the upward direction as the lower wind pressure value V₂ gets lower.

Accordingly, it is possible to further improve operability of the user. In addition, at least one of the movement amount of scrolling and the speed of scrolling may be controlled.

When the screen of the display device 22 is scrolled in the upward direction, the magnitude of the absolute value |V₁−V₂| of the difference between the upper wind pressure value V₁ and the lower wind pressure value V₂ may be used instead of the lower wind pressure value V₂. The movement amount of scrolling and the speed of scrolling may be set by the user.

Returning to FIG. 3, in Step S5, when it is determined that the lower wind pressure value V₂ is less than the upper wind pressure value V₁ (V₂<V₁), that is, when the user blows from the upper portion of the mobile terminal apparatus 1, the process proceeds to Step S7.

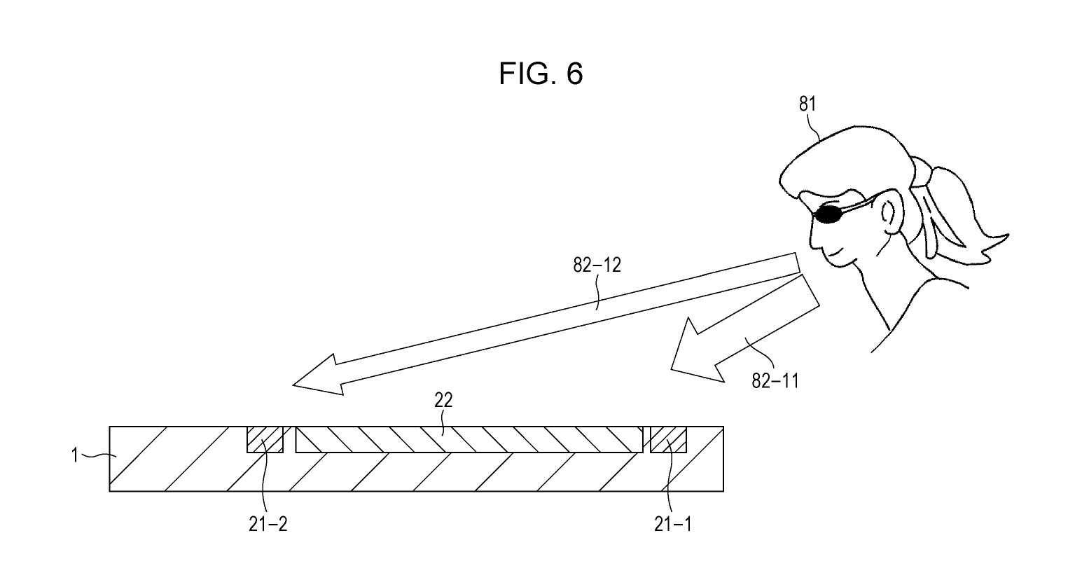

An example when the user blows from the upper portion of the mobile terminal apparatus 1 is shown in FIG. 6.

FIG. 6 is a diagram illustrating an example when the user 81 blows from the upper portion of the mobile terminal apparatus 1.

In the example shown in FIG. 6, the wind pressure 82-11 detected by the wind pressure sensor 21-1 close to the user 81 is represented thicker than the wind pressure 82-12 detected by the wind pressure sensor 21-2 far from the user 81.

That is, the wind pressure 82-11 detected by the wind pressure sensor 21-1 is higher than the wind pressure 82-12 detected by the wind pressure sensor 21-2, and thus the mobile terminal apparatus 1 recognizes that the user 81 blows from the upper portion to the lower portion of the mobile terminal apparatus 1.

Returning to FIG. 3, in Step S7, the control unit 64 scrolls the screen in the downward direction. Accordingly, the screen displayed on the display device 22 is scrolled in the downward direction.

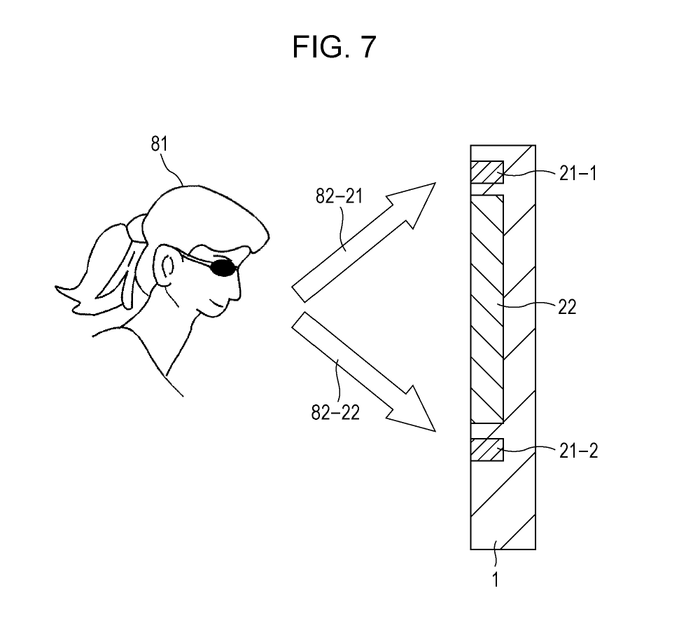

Meanwhile, in Step S4, when it is determined that the absolute value |V₁−V₂| of the difference between the wind pressure values is less than a second threshold value Th₂, that is, when the operation of the user is an item selecting operation, the process proceeds to Step S8. An example in which the item selecting operation is performed by the user is shown in FIG. 7.

FIG. 7 is a diagram illustrating an example of the item selecting operation performed by the user 81. In the example shown in FIG. 7, the wind pressure 82-21 detected by the wind pressure sensor 21-1 and the wind pressure 82-22 detected by the wind pressure sensor 21-2 are represented by substantially the same thickness.

That is, the wind pressure sensor 21-1 and the wind pressure sensor 21-2 are positioned substantially at the same distance from the user 81, and thus the intensity of the wind pressure 82-21 detected by the wind pressure sensor 21-1 and the intensity of the wind pressure 82-22 detected by the wind pressure sensor 21-2 are substantially the same.

Accordingly, the mobile terminal apparatus 1 recognizes that the user 81 blows onto the display device 22.

Returning to FIG. 3, in Step S8, the determination unit 62 determines whether or not there is a selection item. That is, it is determined whether or not the image of the selection item is displayed on the display device 22. The selection item is, for example, a click button or the like, and the selection item is selected to perform a predetermined process.

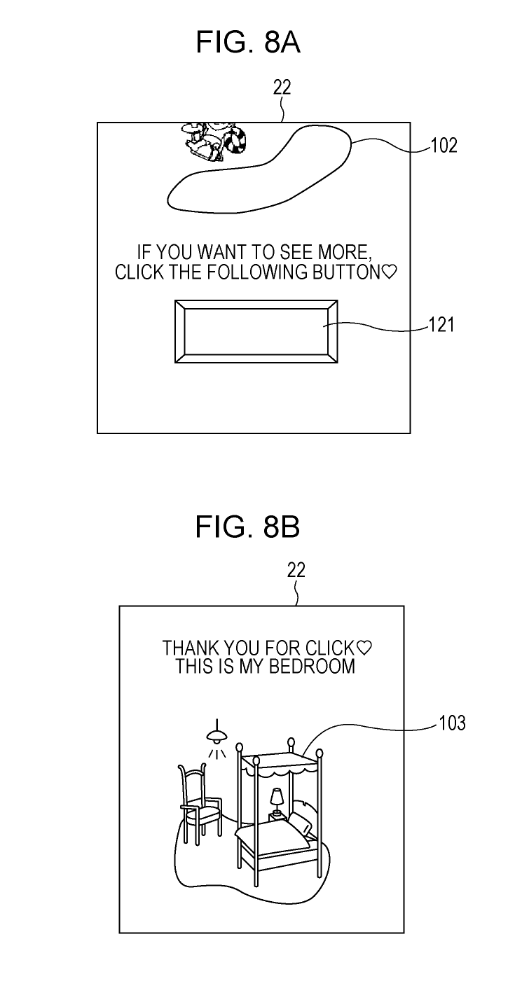

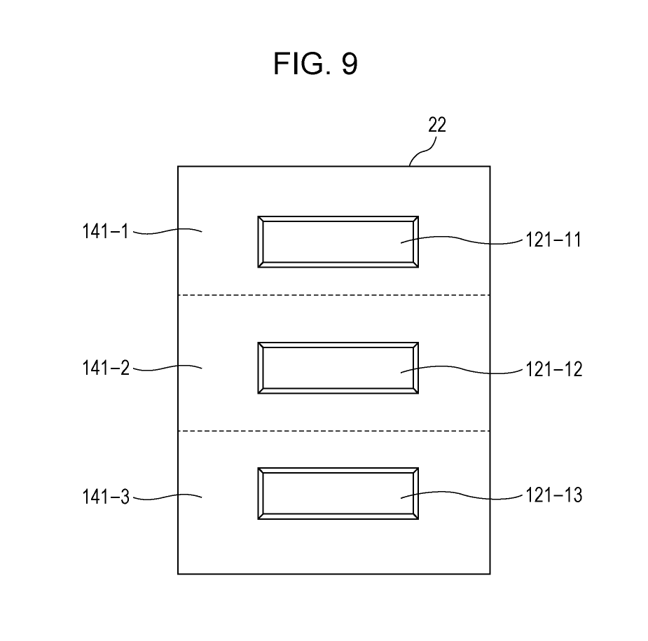

In Step S8, when it is determined that there is a selection item, the process unit 64 selects the selection item in Step S9. An example in which the selection item is displayed on the display device 22 is shown in FIG. 8.

FIG. 8A and FIG. 8B are an example of selecting the selection item. FIG. 8A shows an example in which the pool 102 and the selection item 121 are displayed on the display device 22. FIG. 8B shows an example in which a bed 103 is displayed on the display device 22.

When the selection item 121 shown FIG. 8A is selected, that is, when the user blows onto the display device 22 in the state shown in FIG. 8A, the screen shown in FIG. 8B is displayed on the display device 22.

In FIG. 8B, the bed 103 that is an image of a new homepage linked to the selection item 121 is displayed.

As described above, the mobile terminal apparatus 1 may perform the same process as the process of selecting the item using the enter button 24 or the mouse shown in FIG. 1 on the basis of the wind pressure value acquired from the wind pressure sensor 21.

Returning to FIG. 3, after any one process of Steps S6, S7, and S9, when it is determined that both of the upper wind pressure value V₁ and the lower wind pressure value V₂ are less than the first threshold value Th₁ in Step S2, and when it determined that there is no selection item in Step S8, the process returns to Step S1 and the process thereafter is repeated.

As described above, the mobile terminal apparatus 1 performs the scrolling process or the item selecting process on the basis of the wind pressure values acquired from the wind pressure sensors 21, and thus user can more simply and reliably operate the mobile terminal apparatus 1.

In the embodiment described above, the same process may be performed on the basis of the wind pressure generated when the user operates the mobile terminal apparatus 1 in a predetermined direction, in addition to blowing by the user.

When there is a plurality of selection items 121 shown in FIG. 8A on the display device 22, an arbitrary selection item 121 may be selected by the position upon which the user blows.

An example of selecting an arbitrary selection item from the plurality of the selection items 121 will be described with reference to FIG. 9 to FIG. 13. FIG. 9 is a diagram illustrating an example in which the plurality of selection items 121 is displayed on the display device 22.

As shown in the example of FIG. 9, selection items 121-11, 121-12, and 121-13 are displayed on the display device 22.

The screen of the display device 22 is divided into three parts by the control unit 64, the area 141-1 is the first area, the area 141-2 is the second area, and the area 141-3 is the third area.

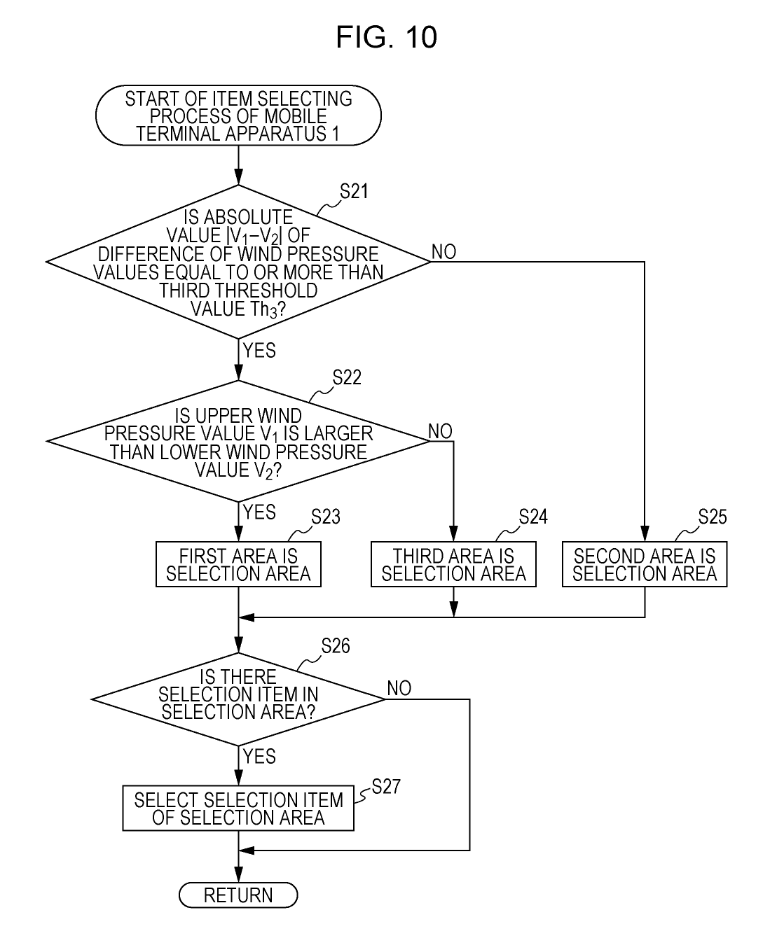

The method of dividing the screen of the display device 22 is not limited to the division of three parts. That is, the number of areas set on the screen of the display device 22 may be two, four, or more. For example, when the number of divisions is two, the process of Step S21 shown in FIG. 10 may be omitted.

[Item Selecting Process of Mobile Terminal Apparatus 1]

FIG. 10 is a flowchart illustrating the item selecting process of the mobile terminal apparatus 1. The item selecting process shown in FIG. 10 is performed instead of the process of Step S9 shown in FIG. 3.

In Step S21, the determination unit 62 determines whether or not the absolute value |V₁−V₂| of the difference between the wind pressure values is equal to or more than a third threshold value Th₃. That is, it is determined whether or not |V₁−V₂|≧Th₃.

The third threshold value Th₃ is a threshold value set to determine whether or not the center of the display device 22, for example, the area 141-2 shown in FIG. 9, is blown upon.

In Step S21, when it is determined that the absolute value |V₁−V₂| of the difference between the wind pressure values is equal to or more than the third threshold value Th₃, the determination unit 62 determines whether or not the upper wind pressure value V₁ is more than the lower wind pressure value V₂ in Step S22.

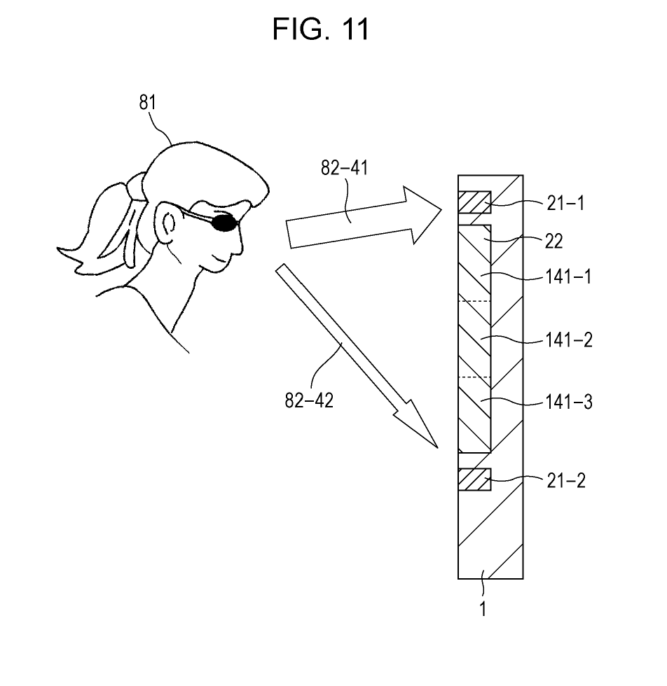

In Step S22, when it is determined that the upper wind pressure value V₁ is more than the lower wind pressure value V₂, that is, V₁>V₂, the control unit 64 sets the first area as the selection area in Step S23. An example when the first area is set as the selection area will be described with reference to FIG. 11.

FIG. 11 is a diagram illustrating the example when the first area is set.

As shown in FIG. 11, when the user 81 blows on the upper portion of the display device 22, the wind pressure 82-41 detected by the wind pressure sensor 21-1 close to the user 81 is higher than the wind pressure 82-42 detected by the wind pressure sensor 21-2 far from the user 81 by a predetermined value or more.

In this case, the area 141-1 of the display device 22, that is, the first area is set as the selection area.

Returning to FIG. 10, in Step S22, when it is determined that the upper wind pressure value V1 is less than the lower wind pressure value V2, that is, V1<V2, the control unit 64 sets the third area as the selection area in Step S24.

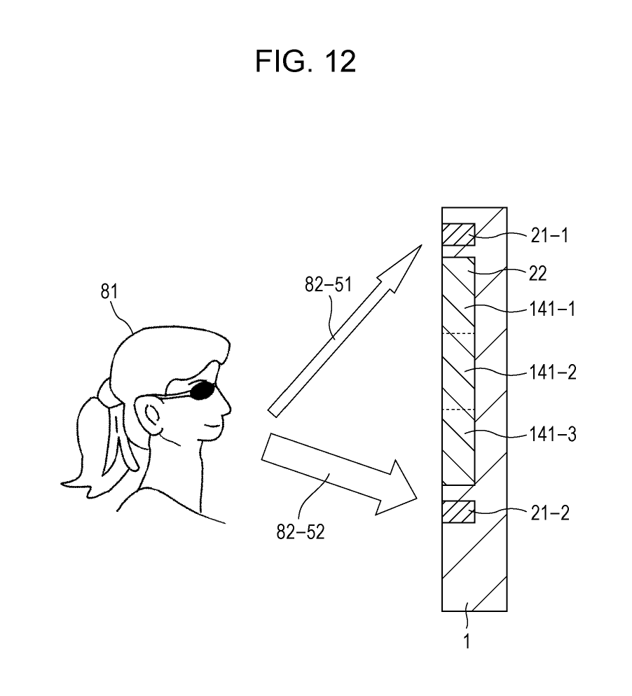

An example in which the third area is set as the selection area will be described with reference to FIG. 12.

FIG. 12 is a diagram illustrating the example in which the third area is set.

As shown in FIG. 12, when the user 81 blows on the lower portion of the display device 22, the wind pressure 82-52 detected by the wind pressure sensor 21-2 close to the user 81 is higher than the wind pressure 82-51 detected by the wind pressure sensor 21-1 far from the user 81 by a predetermined value or more.

In this case, the area 141-3 of the display device 22, that is, the third area is selected as the selection area.

Returning to FIG. 10, in Step S21, when it is determined that the absolute value |V₁−V₂| of the difference between the wind pressure values is less than the third threshold value Th₃, that is, |V₁−V₂|<Th₃, the control unit 64 sets the second area as the selection area in Step S25.

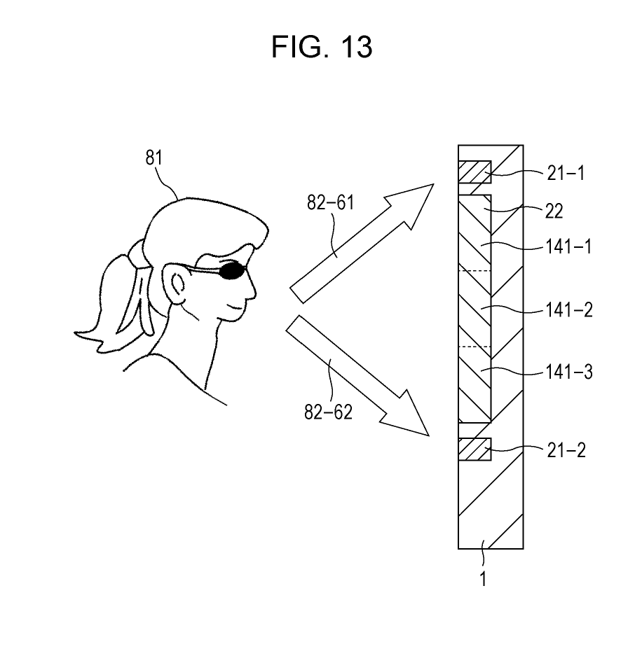

An example in which the second area is set as the selection area will be described with reference to FIG. 13.

FIG. 13 is a diagram illustrating the example in which the second area is set.

As shown in FIG. 13, when the user 81 blows on the center of the display device 22, the magnitude of the wind pressure 82-61 detected by the wind pressure sensor 21-1 and the magnitude of the wind pressure 82-62 detected by the wind pressure sensor 21-2 are substantially the same since the distances from the user 81 are substantially the same.

In this case, the area 141-2 of the display device 22, that is, the second area is set as the selection area.

After any one process of Steps S23, S24, and S25 shown in FIG. 10, the determination unit 62 determines whether or not there is a selection item 121 in the selection area in Step S26. That is, it is determined whether or not the selection item 121 is displayed in the selection area of the display device 22.

In Step S26, when it is determined that there is a selection item 121 in the selection area, the control unit 64 selects the selection item 121 of the selection area in Step S27.

For example, when the first area, that is, the area 141-11 is set as the selection area by the process of Step S23, it is determined whether or not the selection item 121 is displayed in the area 141-11.

In the example shown in FIG. 9, the selection item 121-11 is displayed in the area 141-1 that is the first area of the display 22. In this case, the selection item 121-11 is selected, and a homepage or like linked to the selection item 121-11 is displayed.

The same process is performed even when the second area or the third area, that is, the area 141-12 or the area 141-13 is set.

Returning to FIG. 10, when it is determined that there is no selection item 121 in the selection area after the process of Step S27 or in Step S26, the item selecting process is ended and the process returns to Step S1 shown in FIG. 3.

As described above, in the mobile terminal apparatus 1, the user may select an arbitrary selection item 121 from the plurality of selection items 121, and thus it is possible to perform more various processes on the basis of the wind pressure values acquired from the wind pressure sensors 21.

The mobile terminal apparatus 1 may perform the same operation as the operation of the enter button 24 or the back button 25 on the basis of the wind pressure values acquired from the wind pressure sensors 21.

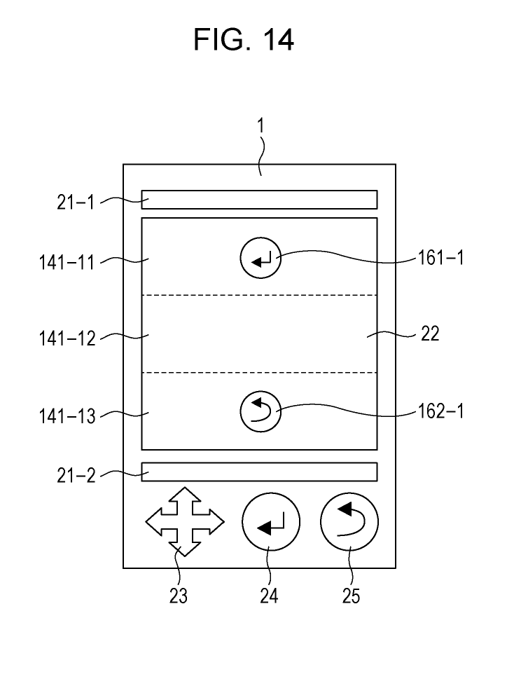

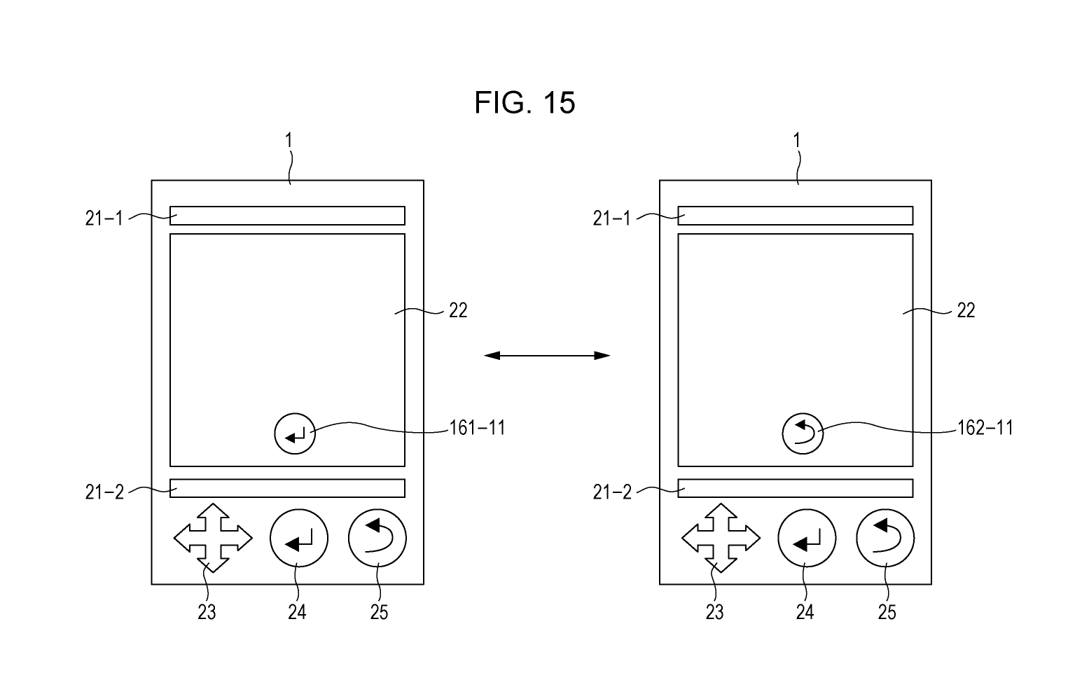

FIG. 14 and FIG. 15 are diagrams illustrating an example of performing the same operation as the operation of the enter button 24 or the back button 25 by the wind pressure.

In the example shown in FIG. 14, an enter icon 161-1 corresponding to the enter button 24 and a back icon 162-1 corresponding to the back button 25 are displayed at predetermined positions of the display device 22.

In the example shown in FIG. 14, the enter ion 161-1 is displayed in the area 141-11, and the back icon 162-1 is displayed in the area 141-13.

As described above, in the example shown in FIG. 14, the enter icon 161-1 and the back icon 162-1 are displayed instead of the selection items 121 shown in FIG. 9. The same process as the item selecting process shown in FIG. 10 is performed, and thus the operation corresponding to the enter button 24 or the back button 25 is performed.

For example, when the user blows on the area 141-11, the enter icon 161-1 is selected and the operation corresponding to the enter button 24 is performed.

When the user blows on the area 141-13, the back icon 162-1 is selected and the operation corresponding to the back button 25 is performed.

Accordingly, it is possible to more rapidly realize the same operation as the operation of the enter button 24 or the back button 25 on the basis of the wind pressure values acquired from the wind pressure sensors 21.

FIG. 15 is a diagram illustrating an example in which the enter icon 161-11 and the back icon 162-11 are alternately displayed on the display device 22.

In the example shown in FIG. 15, the enter icon 161-11 or the back icon 162-11 is alternately displayed at the same position instead of the selection item 121 shown in FIG. 8A.

On the left side of FIG. 15, a state of displaying the enter icon 161-11 on the display device 22 is shown. In the left state of FIG. 15, when a predetermined waiting time is elapsed, the screen of the display device 22 is changed from the left screen of FIG. 15 to the right screen of FIG. 15.

That is, the icon that is the selection item 121 displayed on the display device 22 is changed from the enter icon 161-11 to the back icon 162-11.

In the right state of FIG. 15, when a predetermined waiting time is elapsed, the screen of the display device 22 is changed again from the right screen of FIG. 15 to the left screen of FIG. 15.

That is, the icon that is the selection item 121 displayed on the display device 22 is changed from the back icon 162-11 to the enter icon 161-11.

For example, when the enter icon 161-11 is displayed on the display device 22 and the user blows on the display device 22, the enter icon 161-11 is selected and the operation corresponding to the enter button 24 is performed.

When the back icon 162-11 is displayed on the display device 22 and the user blows on the display device 22, the back icon 162-11 is selected and the operation corresponding to the back button 25 is performed.

As described above, the same process as the process of Step S9 shown in FIG. 3 is performed.

Accordingly, it is possible to realize the same operation as the operation of the enter button 24 or the back button 25 without interfering with the display of the image of the display device 22 on the basis of the wind pressure values acquired from the wind pressure sensors 21.

The number of screens of the display device 22 changed for each predetermined waiting time may be 3 or more. The waiting time may be changed for a predetermined screen.

The position of the icon as the selection item 121 displayed on the display device 22 is not limited to the example shown in FIG. 15, and may be on the screen of the display device 22.

As shown in the example of FIG. 15, when the enter icon 161-11 is displayed at the lower portion of the center, it is possible to more reliably perform the process without interfering with the display of the image of the display device 22.

The same operation of the operation of the enter button 24 or the back button 25 may be performed by the number of times the display device 22 is blown on without displaying the enter icon 161-11 or the back icon 162-11 on the display device 22.

For example, when the user blows on the display device 22 twice in succession, the operation corresponding to the enter button 24 may be performed, and when the user blows three times in succession, the operation corresponding to the back button 25 may be performed.

Accordingly, it is possible to realize the same operation of the operation of the enter button 24 or the back button 25 further without interfering with the display of the image of the display device 22.

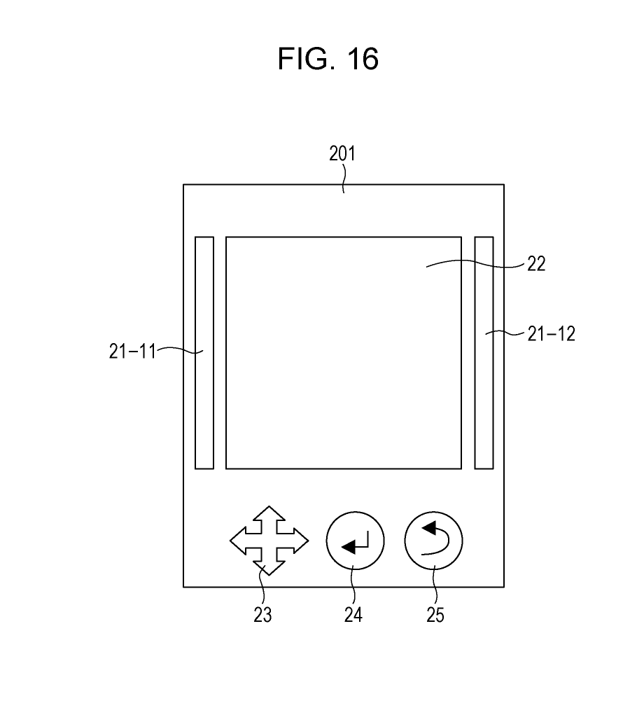

In the embodiment described above, the wind pressure sensors 21 are provided at the upper portion and the lower portion of the display device 22, but the positions of providing the wind pressure sensors 21 are not limited thereto. An example of providing the wind pressure sensors 21 on the left and right of the display device 22 is shown in FIG. 16.

[Configuration of Mobile Terminal Apparatus 201]

FIG. 16 is a diagram illustrating an example of a configuration of a mobile terminal apparatus 201.

In FIG. 16, the same reference numerals and signs are attached to the elements corresponding to those of FIG. 1. That is, the mobile terminal apparatus 201 is different from the mobile terminal apparatus 1 in that wind pressure sensors 21-11 and 21-12 instead of the wind pressure sensors 21-1 and 21-2 are provided, and the other configurations are the same as those of the mobile terminal apparatus 1.

In the example shown in FIG. 16, the wind pressure sensor 21-11 is provided on the left side of the display device 22, and the wind pressure sensor 21-12 is provided on the right side of the display device 22.

[Wind Pressure Control Process of Mobile Terminal Apparatus 201]

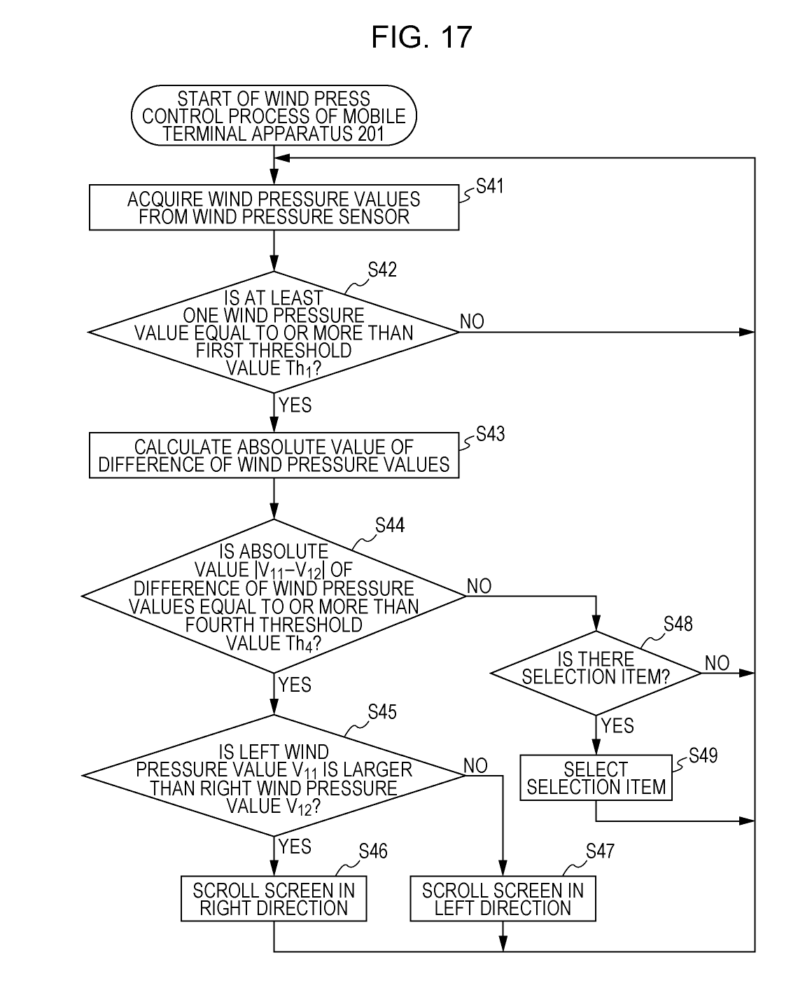

A wind pressure control process of the mobile terminal apparatus 201 will be described with reference to FIG. 17 to FIG. 20. FIG. 17 is a flowchart illustrating the wind pressure control process of the mobile terminal apparatus 201.

In FIG. 17, the processes of Steps S41, S42, S43, S48, and S49 are the process corresponding to Steps S1, S2, S3, S8, and S9 shown in FIG. 3, respectively. Accordingly, such processes are repeated, and thus will be briefly described.

In Step S41, the acquisition unit 61 acquires a wind pressure value from the wind pressure sensor 21. That is, an upper wind pressure value V₁₁ is acquired from the left wind pressure sensor 21-11 of the mobile terminal apparatus 201, and a right wind pressure value V₁₂ is acquired from the right wind pressure sensor 21-12.

In Step S42, the determination unit 62 determines whether or not at least one wind pressure value is equal to or more than a first threshold value Th₁. That is, at least one of the acquired left wind pressure value V₁₁ and the right wind pressure value V₁₂ is equal to or more than the first threshold value Th₁.

In Step S42, when it is determined that at least one wind pressure value is equal to or more than the first threshold value Th₁, the calculation unit 63 calculates the absolute value of the difference between the wind pressure values in Step S43. That is, the absolute value |V₁₁−V₁₂| of the difference between the left wind pressure value V₁₁ and the right wind pressure value V₁₂ is calculated.

In Step S44, the determination unit 62 determines whether or not the absolute value |V₁₁−V₁₂| of the difference between the wind pressure values is equal to or more than a fourth threshold value Th₄. That is, it is determined whether or not |V₁₁−V₁₂|≧Th₄.

The fourth threshold value Th₄ is a threshold value set to determine whether or not the user blows to the inside of the left sensor 21-11 and the right sensor 21-12, that is, on the display device 22.

That is, by the process of Step S44, it is determined whether the operation of the user is a scrolling operation or an item selecting operation.

In Step S44, when it is determined that the absolute value |V₁₁−V₁₂| of the difference between the wind pressure values is equal to or more than the fourth threshold value Th₄, that is, when it is determined that the operation of the user is the scrolling operation, the process proceeds to Step S45.

In Step S45, the determination unit 62 determines whether or not the left wind pressure value V₁₁ is more than the right wind pressure value V₁₂. That is, it is determined whether the direction in which the user blows is from the left side or from the right side of the mobile terminal apparatus 201.

In Step S45, when it is determined that the left wind pressure value V₁₁ is more than the right wind pressure value V₁₂ (V₁₁>V₁₂), that is, when the user blows from the left side of the mobile terminal apparatus 201, the process proceeds to Step S46.

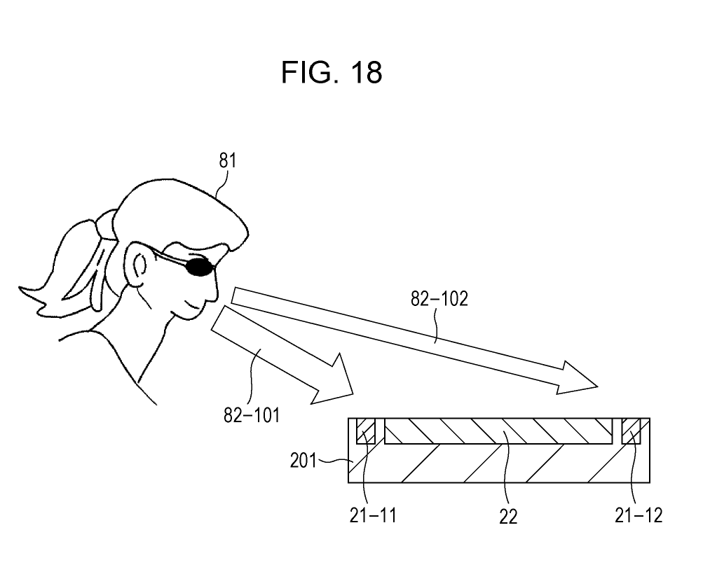

An example when the user blows from the left side of the mobile terminal apparatus 201 will be described with reference to FIG. 18.

FIG. 18 is a diagram illustrating an example when the user 81 blows from the left side of the mobile terminal apparatus 201. In the example shown in FIG. 18, a diagram as viewing the mobile terminal apparatus 201 from the lower portion is shown.

In the example shown in FIG. 18, the wind pressure 82-101 is represented thicker than the wind pressure 82-102. That is, the wind pressure 82-101 detected by the wind pressure sensor 21-11 close to the user 81 is higher than the wind pressure 82-102 detected by the wind pressure sensor 21-12 far from the user 81.

Accordingly, the mobile terminal apparatus 201 recognizes that the user 81 blows from the left side to the right side of the mobile terminal apparatus 201.

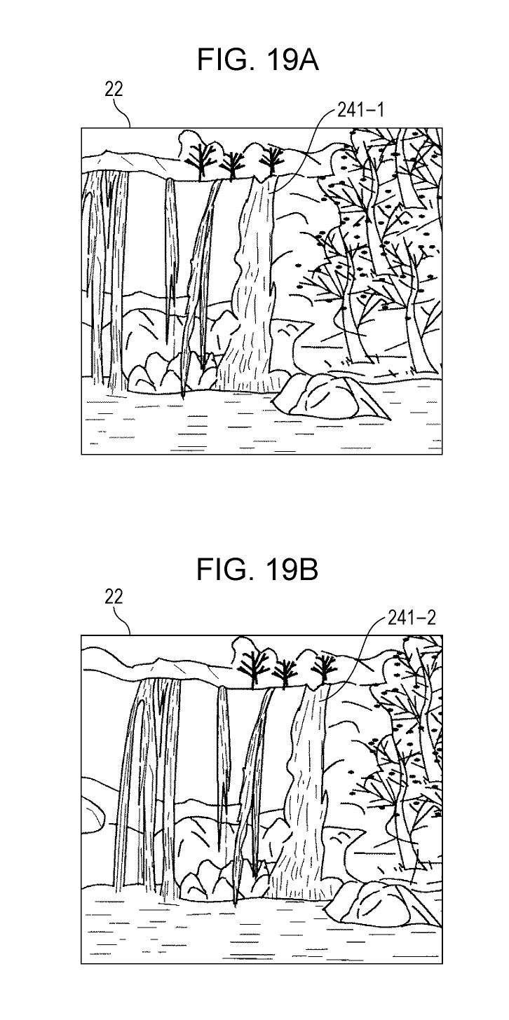

Returning to FIG. 17, in Step S46, the control unit 64 scrolls the screen in the rightward direction. An example of scrolling the screen in the rightward direction will be described with reference to FIG. 19A and FIG. 19B. FIG. 19A and FIG. 19B are diagrams illustrating an example in which an image of a waterfall 241 is displayed on the display device 22.

FIG. 19A shows a state where the waterfall 241-1 is displayed at the center of the screen of the display device 22. FIG. 19B shows a state where the waterfall 241-2 is displayed on the right side of the screen of the display device 22.

When the user blows from the left side of the mobile terminal apparatus 201 in the state shown in FIG. 19A, that is, the screen is scrolled in the rightward direction, the screen of the FIG. 19B is displayed on the display device 22.

That is, the display position of the waterfall 241-1 of FIG. 19A is moved from the center to the right side, and becomes the display position of the waterfall 241-2 of FIG. 19B.

As described above, the mobile terminal apparatus 201 performs the same process as the process of scrolling the screen using the mouse, the cross key, or the like,

Returning to FIG. 17, in Step S45, when it is determined that the left wind pressure value V₁₁ is less than the right wind pressure value V₁₂ (V₁₁<V₁₂), that is, when the user blows from the right side of the mobile terminal apparatus 201, the process proceeds to Step S47.

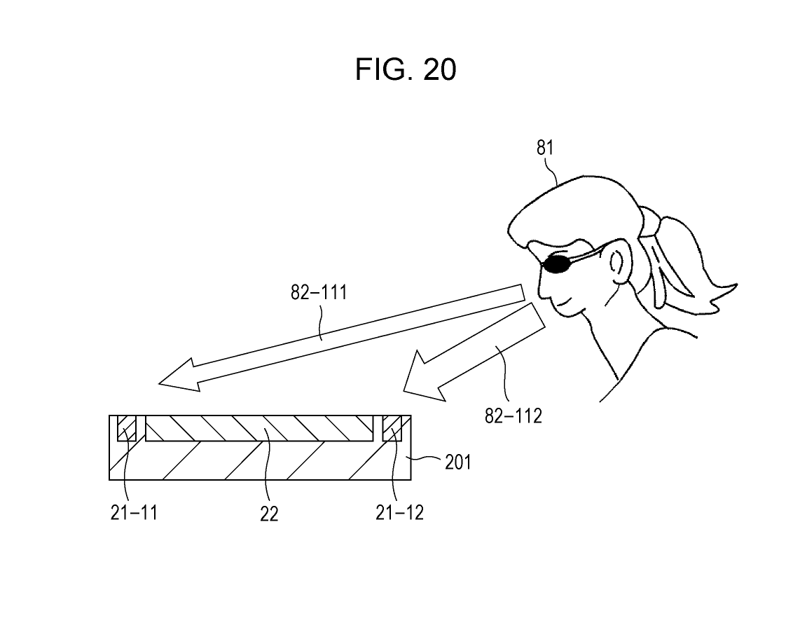

An example when the user blows from the right side of the mobile terminal apparatus 201 will be described with reference to FIG. 20.

FIG. 20 is a diagram illustrating the example when the user 81 blows from the right side of the mobile terminal apparatus 201. In the example shown in FIG. 20, a diagram as viewing the mobile terminal apparatus 201 from the lower portion is shown.

In the example shown in FIG. 20, the wind pressure 82-112 detected by the wind pressure sensor 21-12 is represented thicker than the wind pressure 82-111 detected by the wind pressure sensor 21-11.

That is, the wind pressure 82-112 detected by the wind pressure sensor 21-12 close to the user 81 is higher than the wind pressure 82-111 detected by the wind pressure sensor 21-11 far from the user 81.

Accordingly, the mobile terminal apparatus 201 recognizes that the user 81 blows from the right side to the left side of the mobile terminal apparatus 201.

Returning to FIG. 17, in Step S47, the control unit 64 scrolls the screen in the leftward direction. Accordingly, the screen displayed on the display device 22 is scrolled in the leftward direction.

Meanwhile, in Step S44, when it is determined that the absolute value |V₁₁−V₁₂| of the difference between the wind pressure values is less than the fourth threshold value Th₄, that is, when it is determined that the operation of the user is the item selecting operation, the process proceeds to Step S48.

In Step S48, the determination unit 62 determines whether or not there is a selection item. In Step S48, when it is determined that there is a selection item, the process unit 64 selects the selection item in Step S49.

After any one process of Steps S46, S47, and S49, when it is determined that both of the left wind pressure value V₁₁ and the right wind pressure value V₁₂ are less than the first threshold value Th₁ in Step S42, and when it determined that there is no selection item in Step S48, the process returns to Step S41 and the process thereafter is repeated.

### Second Embodiment

### Configuration of Mobile Terminal Apparatus 301

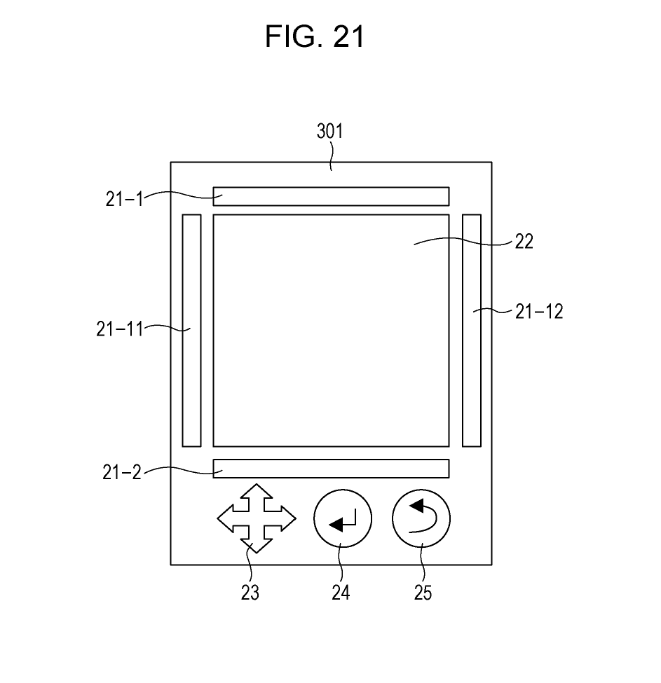

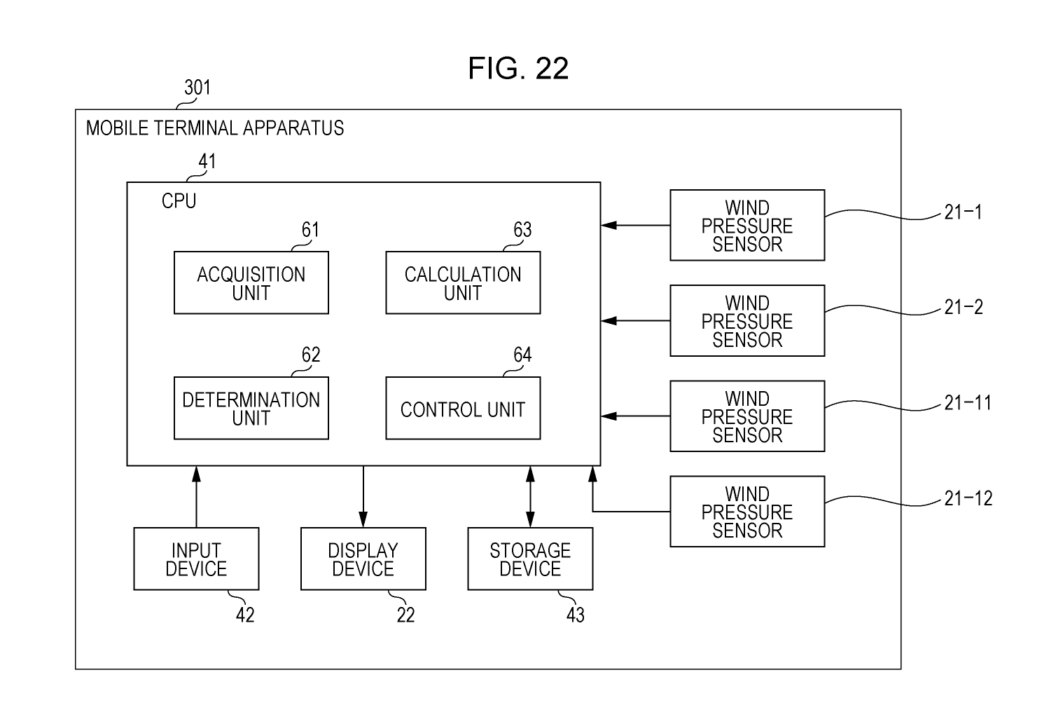

FIG. 21 is a diagram illustrating an example of a configuration of a mobile terminal apparatus 301 according to a second embodiment. FIG. 22 is a block diagram illustrating an example of a configuration of the mobile terminal apparatus 301.

In the mobile terminal apparatus 301 shown in FIG. 21 and FIG. 22, the same reference numerals and signs are attached to the elements corresponding to the mobile terminal apparatus 1 of FIG. 1 and FIG. 2. That is, the mobile terminal apparatus 301 is different from the mobile terminal apparatus 1 in that the wind pressure sensors 21-11 and 21-12 are provided, and the other configurations are the same as those of the mobile terminal apparatus 1.

In the example shown in FIG. 21, similarly to the example shown in FIG. 16, the wind pressure sensor 21-11 is provided on the left side of the display device 22, and the wind pressure sensor 21-12 is provided on the right side of the display device 22. That is, in the example shown in FIG. 21 and FIG. 22, the mobile terminal apparatus 301 is provided with four wind pressure sensors 21.

[Wind Pressure Control Process of Mobile Terminal Apparatus 301]

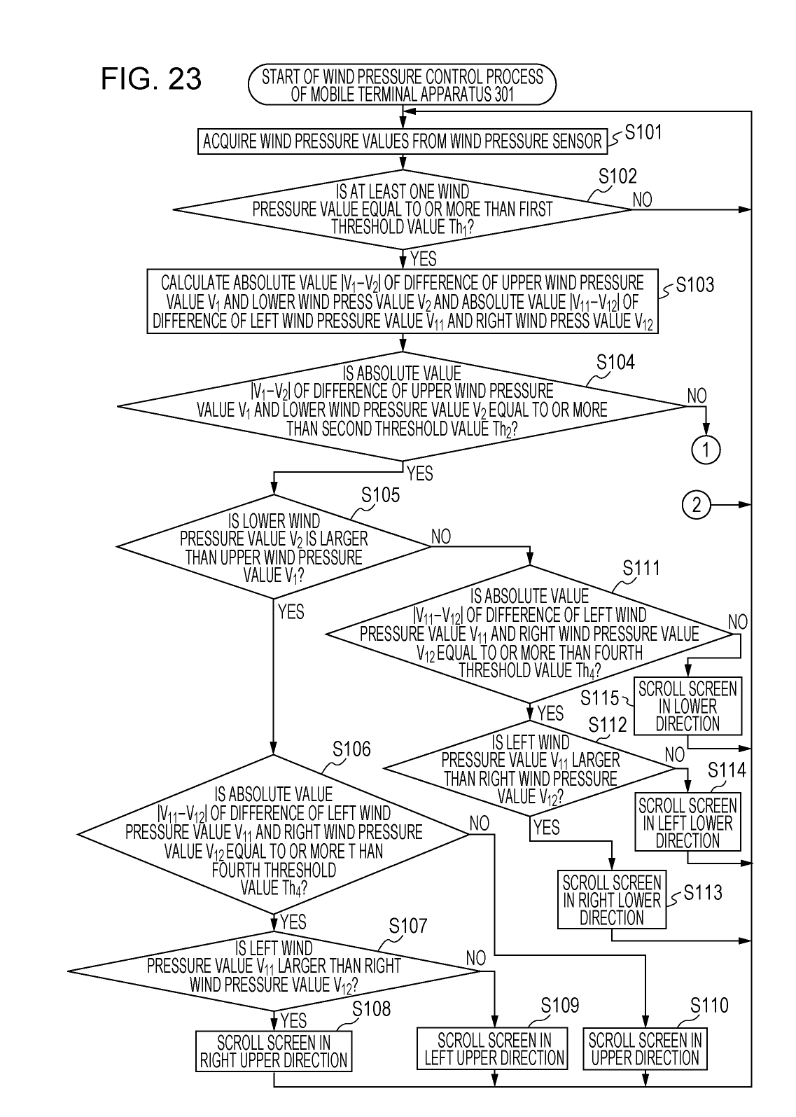

A wind pressure control process of the mobile terminal apparatus 301 will be described with reference to FIG. 23 to FIG. 27B.

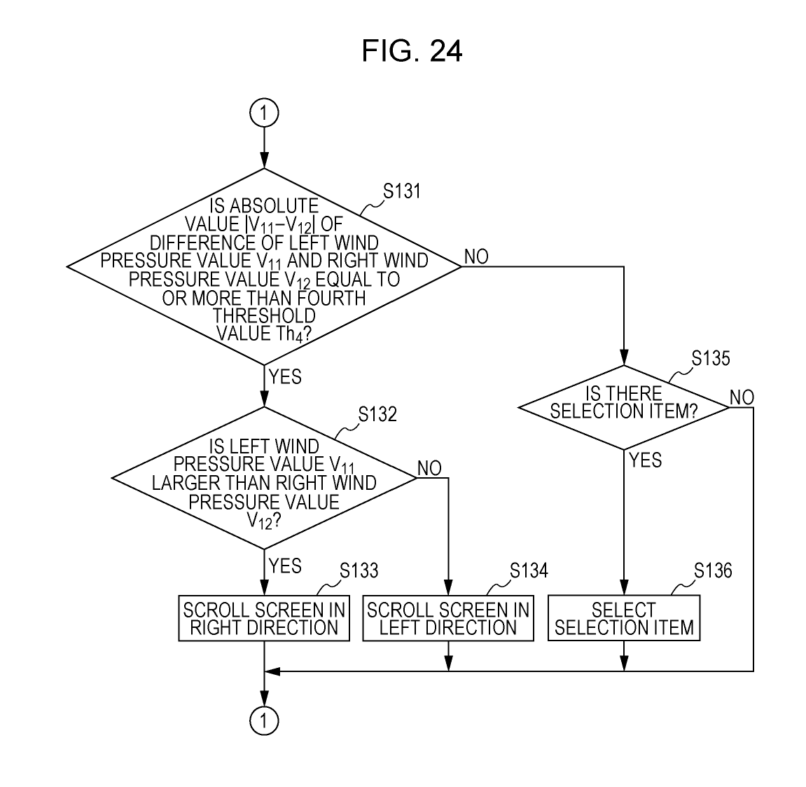

FIG. 23 and FIG. 24 are flowcharts illustrating the wind pressure control process of the mobile terminal apparatus 301. The wind pressure control process is performed when the wind pressure sensor 21 detects wind pressure.

In FIG. 23 and FIG. 24, the processes of Steps S101, S102, S104, S105, S110, S115, S135, and S136 are the process corresponding to Steps S1, S2, S4, S5, S6, S7, S8, and S9 shown in FIG. 3, respectively. Accordingly, such processes are repeated, and thus will be briefly described.

In Step S101, the acquisition unit 61 acquires a wind pressure value from the wind pressure sensor 21.

That is, an upper wind pressure value V₁ is acquired from the upper wind pressure sensor 21-1, a lower wind pressure value V₂ is acquired from the lower wind pressure sensor 21-2, a left wind pressure value V₁₁ is acquired from the left wind pressure sensor 21-11, and a right wind pressure value V₁₂ is acquired from the right wind pressure sensor 21-12.

In Step S102, the determination unit 62 determines whether or not at least one wind pressure value is equal to or more than the first threshold value Th₁. That is, at least one of the acquired upper wind pressure value V₁, lower wind pressure value V₂, left wind pressure value V₁₁, and the right wind pressure value V₁₂ is equal to or more than the first threshold value Th₁.

In Step S102, when it is determined that at least one wind pressure value is equal to or more than the first threshold value Th₁, that is, when it is determined that the user is blowing, the process proceeds to Step S103.

In Step S103, the calculation unit 63 calculates the absolute value |V₁−V₂| of the difference between the upper wind pressure value V₁ and the lower wind pressure value V₂, and the absolute value |V₁₁-V₁₂| of the difference between the left wind pressure value V₁₁ and the right wind pressure value V₁₂.

In Step S104, the determination unit 62 determines whether or not the absolute value |V₁−V₂| of the difference between the upper wind pressure value V₁ and the lower wind pressure value V₂ is equal to or more than the second threshold value Th₂. That is, it is determined whether or not |V₁−V₂|≧Th₂.

In Step S104, when it is determined that the absolute value |V₁−V₂| of the difference between the upper wind pressure value V₁ and the lower wind pressure value V₂ is equal to or more than the second threshold value Th₂, that is, |V₁−V₂|≧Th₂, the process proceeds to Step S105.

In Step S105, the determination unit 62 determines whether or not the lower wind pressure value V₂ is more than the upper wind pressure value V₁. That is, it is determined whether the direction in which the user blows is from the upper portion or from the lower portion of the mobile terminal apparatus 301.

In Step S105, when it is determined that the lower wind pressure value V₂ is more than the upper wind pressure value V₁ (V₂>V₁), that is, when the direction in which the user blows is from the lower portion of the mobile terminal apparatus 301, the process proceeds to Step S106.

In Step S106, the determination unit 62 determines whether or not the absolute value |V₁₁-V₁₂| of the difference between the left wind pressure value V₁₁ and the right wind pressure value V₁₂ is equal to or more than the fourth threshold value Th₄. That is, it is determined whether or not |V₁₁−V₁₂|≧Th₄.

In Step S106, it is determined that the absolute value |V₁₁−V₁₂| of the difference between the left wind pressure value V₁₁ and the right wind pressure value V₁₂ is equal to or more than the fourth threshold value Th₄, that is, |V₁₁−V₁₂|≧Th₄, the process proceeds to Step S107.

In Step S107, the determination unit 62 determines whether or not the left wind pressure value V₁₁ is more than the right wind pressure value V₁₂. That is, it is determined whether the direction in which the user blows is from the lower left side or from the lower right side of the mobile terminal apparatus 301.

In Step S107, when it is determined that the left wind pressure value V₁₁ is more than the right wind pressure value V₁₂ (V₁₁>V₁₂), that is, when the user blows from the lower left side of the mobile terminal apparatus 301, the process proceeds to Step S108.

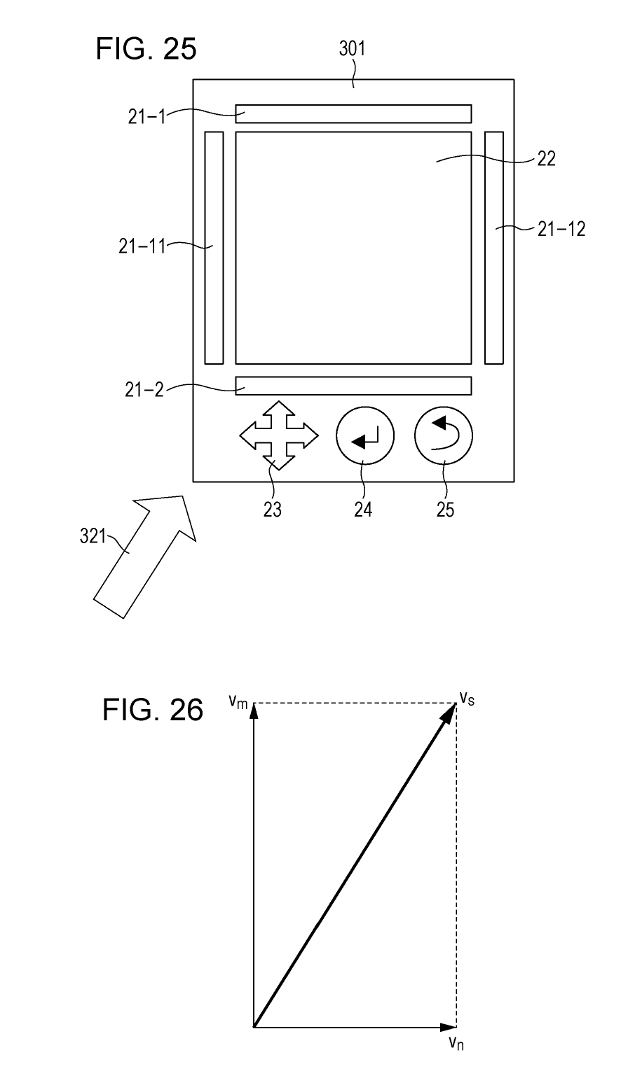

An example when the user blows from the lower left side of the mobile terminal apparatus 301 will be described with reference to FIG. 25.

FIG. 25 is a diagram illustrating an example when breath 321 is blown from the lower left side of the mobile terminal apparatus 301.

When breath 321 is blown onto the mobile terminal apparatus 301, the wind pressure sensors 21-1, 21-2, 21-11, and 21-12 acquire the upper wind pressure value V₁, the lower wind pressure value V₂, the left wind pressure value V₁₁, and the right wind pressure value V₁₂, respectively.

A scrolling vector is determined on the basis of the acquired upper wind pressure value V₁, lower wind pressure value V₂, left wind pressure value V₁₁, and right wind pressure value V₁₂.

A method of calculating the scrolling vector will be described with reference to FIG. 26. FIG. 26 is a diagram illustrating an example of calculating the scrolling vector vₛ.

In the operation of scrolling, the upper wind pressure value V₁ has a vector v₁ of the downward direction, the lower wind pressure value V₂ has a vector v₂ of the upward direction, the left wind pressure value V₁₁ has a vector v₁₁ of the rightward direction, and the right wind pressure value V₁₂ has a vector v₁₂ of the leftward direction.

Similarly to the example shown in FIG. 25, when the breath 321 is blown from the lower left side of the mobile terminal apparatus 301, the lower wind pressure value V₂ between the upper wind pressure value V₁ and the lower wind pressure value V₂ is large, and the left wind pressure value V₁₁ between the left wind pressure value V₁₁ and the right wind pressure value V₁₂ is large.

In this case, a magnitude |vₘ| of the vector vₘ of the up and down direction is the movement amount of scrolling corresponding to the lower wind pressure value V₂, and the direction of the vector vₘ is the upward direction that is the direction of the vector v₂ of the lower wind pressure value V₂.

A magnitude |vₙ| of the vector vₙ of the left and rightward direction is the movement amount of scrolling corresponding to the left wind pressure value V₁₁, and the direction of the vector vₙ is the rightward direction that is the direction of the vector v₁₁ of the left wind pressure value V₁₁.

As shown in FIG. 26, it is possible to calculate the scrolling vector vₛ by composing the vₘ and the vₙ. That is, the scrolling vector vₛ is calculated according to at least one of the upper wind pressure value V₁, the lower wind pressure value V₂, the left wind pressure value V₁₁, and the right wind pressure value V₁₂.

The magnitude |vₘ| of the vector vₘ of the up and down direction may be the movement amount of scrolling corresponding to the absolute value |V₁−V₂| of the difference between the vector v₁ of the upper wind pressure value V₁ and the vector v₂ of the lower wind pressure value V₂.

Similarly, the magnitude |vₘ| of the vector vₘ of the left and rightward direction may be the movement amount of scrolling corresponding to the absolute value |V₁₁−V₁₂| of the difference between the vector v₁₁ of the left wind pressure value V₁₁ and the vector v₁₂ of the right wind pressure value V₁₂.

A speed of scrolling may be changed according to the magnitude |vₛ| of the scrolling vector vₛ. The movement amount of scrolling may be fixed, and only the speed of scrolling may be changed.

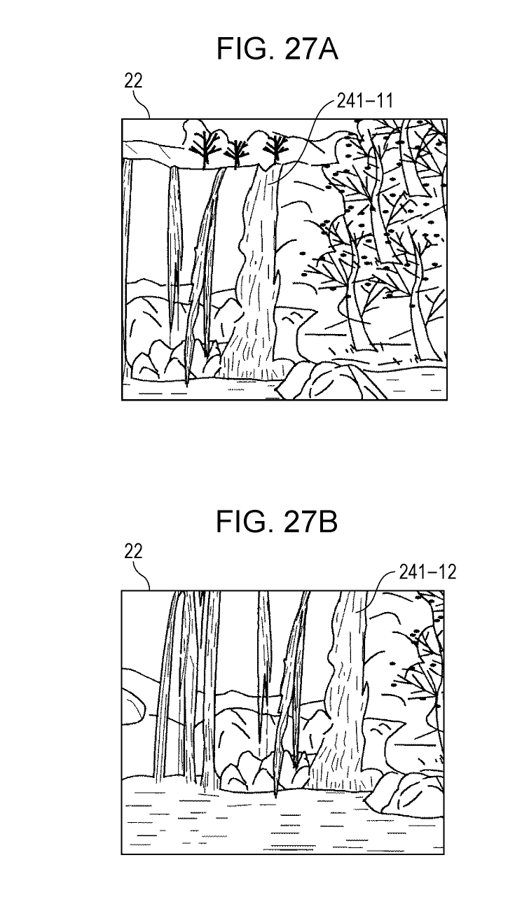

Returning to FIG. 23, in Step S108, the control unit 64 scrolls the screen in the upward right direction. That is, the screen is scrolled in the direction of the scrolling vector vₛ as much as the corresponding movement amount. An example of scrolling the screen in the upward right direction will be described with reference to FIG. 27A and FIG. 27B.

FIG. 27A and FIG. 27B are diagrams illustrating an example in which an arbitrary image is displayed on the display device 22.

FIG. 27A shows a state where a waterfall 241-11 is displayed at the center of the display device 22. FIG. 27B shows a state where a waterfall 241-12 is displayed at the right upper portion of the display device 22.

When the screen is scrolled in the upward right direction from the state shown in FIG. 27A, the screen of FIG. 27B is displayed on the display device 22. That is, the display position of the waterfall 241-11 of FIG. 27A is moved from the center in the upward right direction, and becomes the display position of the waterfall 241-12 of FIG. 27B.

As described above, the mobile terminal apparatus 301 can perform the scrolling operation in the oblique direction in addition to the upward, downward, leftward, and rightward directions on the basis of the wind pressure values acquired from the wind pressure sensors 21.

Returning to FIG. 23, in Step S107, when it is determined that the left wind pressure value V₁₁ is less than the right wind pressure value V₁₂ (V₁₁<V₁₂), that is, when the user blows from the lower right side of the mobile terminal apparatus 301, the process proceeds to Step S109.

In Step S109, the control unit 64 scrolls the screen in the upward left direction.

In Step S106, when it is determined that the absolute value |V₁₁−V₁₂| of the difference between the left wind pressure value V₁₁ and the right wind pressure value V₁₂ is less than the fourth threshold value Th₄, that is, when the user blows from the lower center side of the mobile terminal apparatus 301, the process proceeds to Step S110.

In Step S110, the control unit 64 scrolls the screen in the upward direction.

Meanwhile, in Step S105, when it is determined that the lower wind pressure value V₂ is less than the upper wind pressure V₁ (V₂<V₁), that is, when the user blows from the upper portion of the mobile terminal apparatus 301, the process proceeds to Step S111.

In Step S111, the determination unit 62 determines whether or not the absolute value |V₁₁−V₁₂| of the difference between the left wind pressure value V₁₁ and the right wind pressure value V₁₂ is equal to or more than the fourth threshold value Th₄.

In Step S111, when it is determined that the absolute value |V₁₁-V₁₂| of the difference between the left wind pressure value V₁₁ and the right wind pressure value V₁₂ is equal to or more than the fourth threshold value Th₄, the process proceeds to Step S112.

In Step S112, the determination unit 62 determines whether or not the left wind pressure value V₁₁ is more than the right wind pressure value V₁₂. That is, it is determined whether the direction in which the user blows is from the upper left side or from the upper right side of the mobile terminal apparatus 301.

In Step S112, when it is determined that the left wind pressure value V₁₁ is more than the right wind pressure value V₁₂ (V₁₁>V₁₂), that is, when the user blows from the upper left side of the mobile terminal apparatus 301, the process proceeds to Step S113.

In Step S113, the control unit 64 scrolls the screen in the downward right direction.

Meanwhile, in Step S112, when it is determined that the left wind pressure value V₁₁ is less than the right wind pressure value V₁₂ (V₁₁<V₁₂), that is, when the user blows from the upper right side of the mobile terminal apparatus 301, the process proceeds to Step S114.

In Step S114, the control unit 64 scrolls the screen in the downward left direction.

In Step S111, when it is determined that the absolute value |V_{H}-V₁₂| of the difference between the left wind pressure value V₁₁ and the right wind pressure value V₁₂ is less than the fourth threshold value Th₄, that is, when the user blows from the upper center of the mobile terminal apparatus 301, the process proceeds to Step S115.

In Step S115, the control unit 64 scrolls the screen in the downward direction.

Meanwhile, in Step S104, when it is determined that the absolute value |V₁−V₂| of the difference between the upper wind pressure V₁ and the lower wind pressure value V₂ is less than the second threshold value Th₂, that is, |V₁−V₂|<Th₂, the process proceeds to Step S131 shown in FIG. 24.

In Step S131 shown in FIG. 24, the determination unit 62 determines whether or not the absolute value |V₁₁−V₁₂| of the difference between the left wind pressure value V₁₁ and the right wind pressure value V₁₂ is equal to or more than the fourth threshold value Th₄.

In Step S131, it is determined that the absolute value |V₁₁−V₁₂| of the difference between the left wind pressure value V₁₁ and the right wind pressure value V₁₂ is equal to or more than the fourth threshold value Th₄, the process proceeds to Step S132.

In Step S132, the determination unit 62 determines whether or not the left wind pressure value V₁₁ is more than the right wind pressure value V₁₂. That is, it is determined whether the direction in which the user blows is from the left side or from the right side of the display device 22.

In Step S132, when it is determined that the left wind pressure value V₁₁ is more than the right wind pressure value V₁₂ (V₁₁>V₁₂), that is, when the user blows from the left side of the display device 22, the process proceeds to Step S133.

In Step S133, the control unit 64 scrolls the screen in the rightward direction.

Meanwhile, in Step S132, when it is determined that the left wind pressure value V₁₁ is less than the right wind pressure value V₁₂ (V₁₁<V₁₂), that is, when the user blows from the right side of the display device 22, the process proceeds to Step S134.

In Step S134, the control unit 64 scrolls the screen in the leftward direction.

In Step S131, when it is determined that the absolute value |V₁₁−V₁₂| of the difference between the left wind pressure value V₁₁ and the right wind pressure value V₁₂ is less than the fourth threshold value Th₄, that is, when the user blows from the upper portion of the display device 22, the process proceeds to Step S135.

In Step S135, the determination unit 62 determines whether or not there is a selection item. In Step S135, when it is determined that there is a selection item, the process unit 64 selects the selection item in Step S136.

In the process of Step S102 shown in FIG. 23, the upper wind pressure value V₁, the lower wind pressure value V₂, the left wind pressure value V₁₁, and the right wind pressure value V₁₂ are less than the first threshold value Th₁, the process returns to Step S101 shown in FIG. 23 after the process of Steps S108, S109, S110, S113, S114, or S115 or after the process of Steps S133, S134, or S136 shown in FIG. 24.

As described above, the mobile terminal apparatus 301 can perform more various processes on the basis of the wind pressure values acquired from the wind pressure sensors 21.

Also in the mobile terminal apparatus 301, similarly to the mobile terminal apparatus 1 shown in FIG. 1, it is possible to select an arbitrary selection item 121 from the plurality of selection items 121 displayed on the screen of the display device 22.

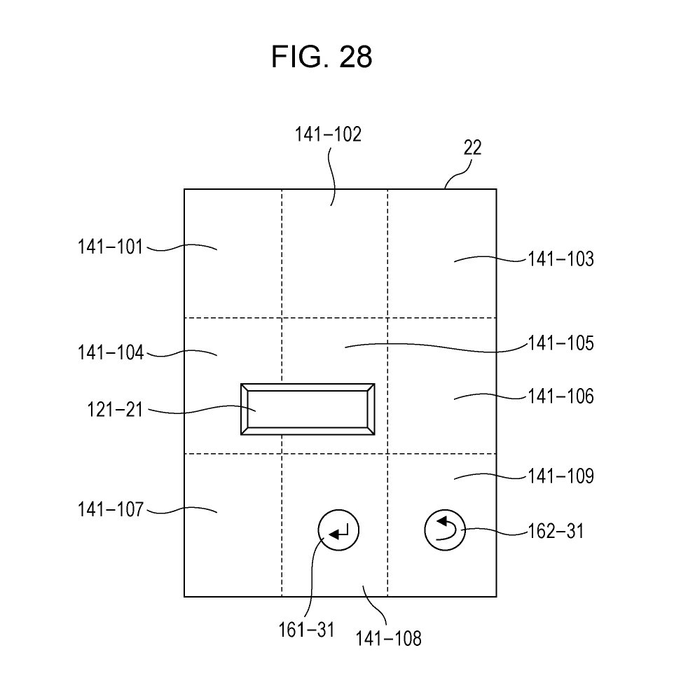

An example of selecting an arbitrary selection item 121 from the plurality of selection items 121 will be described with reference to FIG. 28 to FIG. 30.

FIG. 28 is a diagram illustrating an example of selecting an item. As shown in the example of FIG. 28, a selection item 121-21, an enter icon 161-31, and a back icon 162-31 are displayed on the screen of the display device 22.

In the example shown in FIG. 28, the screen of the display device 22 is divided into three parts vertically and horizontally, that is, in the up and down direction and the left and rightward direction by the control unit 64. That is, nine areas are set on the display device 22.

An area 141-101 is a first area, an area 141-102 is a second area, an area 141-103 is a third area, an area 141-104 is a fourth area, an area 141-105 is a fifth area, an area 141-106 is a sixth area, an area 141-107 is a seventh area, an area 141-108 is an eighth area, and an area 141-109 is a ninth area.

A method of dividing the screen of the display device 22 is not limited to nine. That is, the number of areas set on the screen of the display device 22 may arbitrarily set.

[Item Selecting Process]

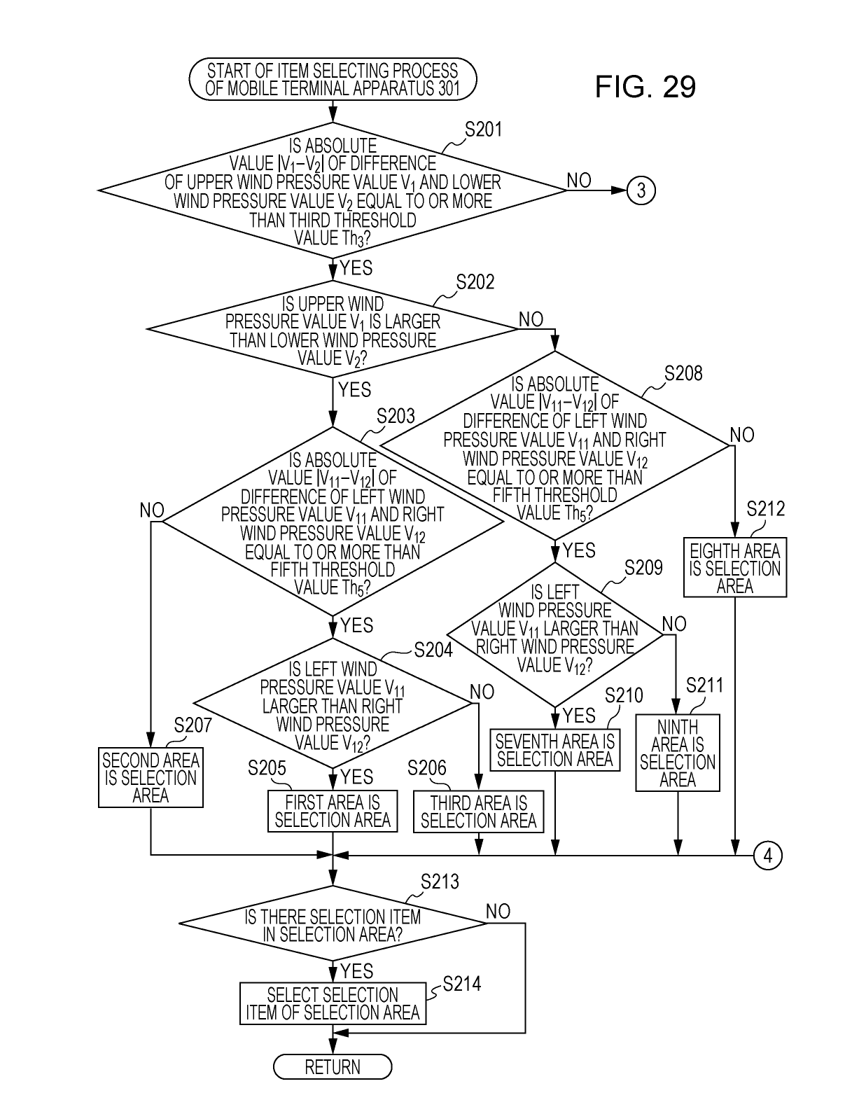

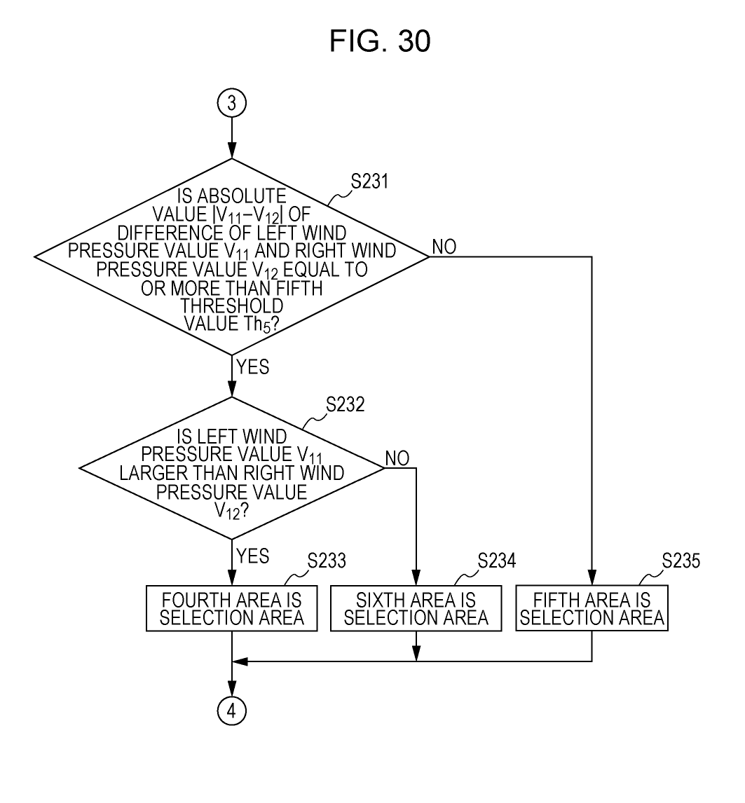

FIG. 29 and FIG. 30 are flowcharts illustrating an item selecting process of the mobile terminal apparatus 301.

In FIG. 29 and FIG. 30, the processes of Steps S201, S202, S213, and S214 are the processes corresponding to Steps S21, S22, S26, and S27 shown in FIG. 10. Accordingly, such processes are repeated, and thus will be briefly described.

The item selecting process shown in FIG. 29 and FIG. 30 is performed instead of Step S136 shown in FIG. 24.

In Step S201, the determination unit 62 determines whether or not the absolute value |V₁−V₂| of the difference between the upper wind pressure value V₁ and the lower wind pressure value V₂ is equal to or more than the third threshold value Th₃.

In Step S201, it is determined that the absolute value |V₁−V₂| of the difference between the upper wind pressure values is equal to or more than the third threshold value Th₃, the determination unit 62 determines whether or not the upper wind pressure value V₁ is more than the lower wind pressure value V₂ in Step S202.

In Step S202, when it is determined that the upper wind pressure value V₁ is more than the lower wind pressure value V₂, that is, V₁>V₂, the process proceeds to Step S203.

In Step S203, the determination unit 62 determines whether or not the absolute value |V₁₁−V₁₂| of the difference between the left wind pressure value V₁₁ and the right wind pressure value V₁₂ is equal to or more than a fifth threshold value Th₅. That is, it is determined whether or not |V₁₁−V₁₂|≧Th₅.

The fifth threshold value Th₅ is a threshold value set to determine whether or not the center of the display device 22 in the transverse direction, for example, the area 141-102, 141-105, or 141-108 shown in FIG. 28, is blown on.

In Step S203, when it is determined that the absolute value |V₁₁−V₁₂| of the difference between the left wind pressure value V₁₁ and the right wind pressure value V₁₂ is equal to or more than the fifth threshold value Th₅, the process proceeds to Step S204.

In Step S204, the determination unit 62 determines whether or not the left wind pressure value V₁₁ is more than the right wind pressure value V₁₂. That is, it is determined whether the position upon which the user blows is the left upper area or the right upper area of the display device 22.

In Step S204, when it is determined that the left wind pressure value V₁₁ is more than the right wind pressure value V₁₂ (V₁₁>V₁₂), that is, when the user blows on the left upper area of the display device 22, the process proceeds to Step S205.

In Step S205, the control unit 64 sets the first area as the selection area. That is, the area 141-101 that is the first area of the display device 22 shown in FIG. 28 is set as the selection area.

In Step S204, when it is determined that the left wind pressure value V₁₁ is less than the right wind pressure value V₁₂, that is, when the user blows on the right upper area of the display device 22, the process proceeds to Step S206.

In Step S206, the control unit 64 sets the third area as the selection area. That is, the area 141-103 that is the third area of the display device 22 shown in FIG. 28 is set as the selection area.

In Step S203, when it is determined that the absolute value |V_{H}-V₁₂| of the difference between the left wind pressure value V₁₁ and the right wind pressure value V₁₂ is less than the fifth threshold value Th₅, that is, when the user blows on the upper center of the display device 22, the process proceeds to Step S207.

In Step S207, the control unit 64 sets the second area as the selection area. That is, the area 141-102 that is the second area of the display device 22 shown in FIG. 28 is set as the selection area.

In Step S202, when it is determined that the upper wind pressure value V₁ is less than the lower wind pressure value V₂, that is, V₁<V₂, the process proceeds to Step S208.

In Step S208, the determination unit 62 determines whether or not the absolute value |V₁₁−V₁₂| of the difference between the left wind pressure value V₁₁ and the right wind pressure value V₁₂ is equal to or more than the fifth threshold value Th₅.

In Step S208, when it is determined that the absolute value |V₁₁−V₁₂| of the difference between the left wind pressure value V₁₁ and the right wind pressure value V₁₂ is equal to or more than the fifth threshold value Th₅, the process proceeds to Step S209.

In Step S209, the determination unit 62 determines whether or not the left wind pressure value V₁₁ is more than the right wind pressure value V₁₂. That is, it is determined whether the position upon which the user blows is the left lower area or the right lower area of the display device 22.

In Step S209, when it is determined that the left wind pressure value V₁₁ is more than the right wind pressure value V₁₂ (V_{H}>V₁₂), that is, when the user blows on the left lower area of the display device 22, the process proceeds to Step S210.

In Step S210, the control unit 64 sets the seventh area as the selection area. That is, the area 141-107 that is the seventh area of the display device 22 shown in FIG. 28 is set as the selection area.

In Step S209, when it is determined that the left wind pressure value V₁₁ is less than the right wind pressure value V₁₂, that is, when the user blows on the right lower area of the display device 22, the process proceeds to Step S211.

In Step S211, the control unit 64 sets the ninth area as the selection area. That is, the area 141-109 that is the ninth area of the display device 22 shown in FIG. 28 is set as the selection area.

In Step S208, when it is determined that the absolute value |V₁₁−V₁₂| of the difference between the left wind pressure value V₁₁ and the right wind pressure value V₁₂ is less than the fifth threshold value Th₅, that is, when the user blows on the lower center of the display device 22, the process proceeds to Step S212.

In Step S212, the control unit 64 sets the eighth area as the selection area. That is, the area 141-108 that is the eighth area of the display device 22 shown in FIG. 28 is set as the selection area.

In Step S201, when it is determined that the absolute value |V₁−V₂| of the difference between the upper wind pressure value V₁ and the lower wind pressure value V₂ is less than the third threshold value Th₃, the process proceeds to Step S231 shown in FIG. 30.

In Step S231 shown in FIG. 30, the determination unit 62 determines whether or not the absolute value |V₁₁−V₁₂| of the difference between the left wind pressure value V₁₁ and the right wind pressure value V₁₂ is equal to or more than the fifth threshold value Th₅.

In Step S231, it is determined that the absolute value |V₁₁−V₁₂| of the difference between the left wind pressure value V₁₁ and the right wind pressure value V₁₂ is equal to or more than the fifth threshold value Th₅, the process proceeds to Step S232.

In Step S232, the determination unit 62 determines whether or not the left wind pressure value V₁₁ is more than the right wind pressure value V₁₂. That is, it is determined whether the position upon which the user blows is the left center area or the right center area of the display device 22.

In Step S232, when it is determined that the left wind pressure value V₁₁ is more than the right wind pressure value V₁₂ (V₁₁>V₁₂), that is, when the user blows on the left center area of the display device 22, the process proceeds to Step S233.

In Step S233, the control unit 64 sets the fourth area as the selection area. That is, the area 141-104 that is the fourth area of the display device 22 shown in FIG. 28 is set as the selection area.

In Step S232, when it is determined that the left wind pressure value V₁₁ is less than the right wind pressure value V₁₂ (V₁₁<V₁₂), that is, when the user blows on the right center area of the display device 22, the process proceeds to Step S234.

In Step S234, the control unit 64 sets the sixth area as the selection area. That is, the area 141-106 that is the sixth area of the display device 22 shown in FIG. 28 is set as the selection area.

In Step S231, when it is determined that the absolute value |V₁₁−V₁₂| of the difference between the left wind pressure value V₁₁ and the right wind pressure value V₁₂ is less than the fifth threshold value Th₅, that is, when the user blows on the center area of the display device 22, the process proceeds to Step S235.

In Step S235, the control unit 64 sets the fifth area as the selection area. That is, the area 141-105 that is the fifth area of the display device 22 shown in FIG. 28 is set as the selection area.

After any one process of Steps S205, S206, S207, S210, S211, and S212 shown in FIG. 29, and Steps S233, S234, and S235 shown in FIG. 30, the determination unit 62 determines whether or not there is a selection area 121 in the selection area in Step S213 shown in FIG. 29.

In Step S213, when it is determined that there is a selection item 121 in the selection area, the control unit 64 selects the selection item 121 of the selection area in Step S214.

For example, when the fourth area, that is, the area 141-104 shown in FIG. 28 is set as the selection area by the process of Step S233 shown in FIG. 30, the selection item 121-21 is selected and a homepage or the like linked to the selection item 121-21 is displayed.

The selection item 121-21 shown in FIG. 28 is displayed over the area 141-104 and the area 141-105, that is, the fourth area and the fifth area.

Accordingly, even when the fifth area is set as the selection area by the process of Step S235 shown in FIG. 30, the selection item 121-21 shown in FIG. 28 is selected.

Similarly to the selection item 121, the enter icon 161 and the back icon 162 may be selected.

For example, when the eighth area, that is, the area 141-108 shown in FIG. 28 is set as the selection area by the process of Step S212 shown in FIG. 29, the enter icon 161-31 is selected.

Meanwhile, when the ninth area, that is, the area 141-109 shown in FIG. 28 is set as the selection area by the process of Step S211 shown in FIG. 29, the back icon 162-31 is selected.

As described above, in the mobile terminal apparatus 301, it is possible to perform the more detailed process on the basis of the wind pressure values acquired from the wind pressure sensor 21.

Returning to FIG. 29, after the process of Step S214 or in Step S213, when it is determined that there is no selection item 121 in the selection area, the item selecting process is completed, and the process proceeds to Step S101 shown in FIG. 23.

[Others]

In the specification, the terms of the system mean that the entire apparatus is configured from a plurality of devices and units.

The embodiments of the present disclosure are not limited to the embodiments described above, and may be variously modified within the scope which does not deviate from the concept of the present disclosure. In the embodiment of the present disclosure, other devices may have a part of functions.

In the embodiments of the present disclosure, the examples in which two or four wind pressure sensors 21 are provided have been described, but the number of wind pressure sensors 21 provided in the mobile terminal apparatus may be three, five, or more.

In the above description, the direction is detected from the difference in magnitude of the plurality of wind pressure values, but the direction may be detected from a difference in time such as timing of detecting the wind pressures. It is preferable to detect a difference of a plurality of wind pressures. Various threshold values may be determined by performing a test.

The present disclosure may be applied to, for example, an information processing apparatus which processes an input from a physically handicapped person who has a trouble in use of fingers, in addition to the mobile terminal apparatus such as a mobile phone, a smart phone, a laptop personal computer.

The present disclosure may have the following configurations.

(1) An information processing apparatus including:

a plurality of wind pressure sensors that detect wind pressures; and

a control unit that controls a predetermined process to be performed according to difference of the wind pressures detected by the plurality of wind pressure sensors.

(2) The information processing apparatus according to (1), further including: a display unit that displays an image; and a calculation unit that calculates the absolute value of the difference of the wind pressures detected by the plurality of wind pressure sensors, wherein the control unit performs the predetermined process on the image displayed on the display unit on the basis of the absolute value calculated by the calculation unit.

(3) The information processing apparatus according to (2), wherein the plurality of wind pressure sensors include a first wind pressure sensor and a second wind pressure sensor provided at predetermined positions around the display unit, wherein the calculation unit calculates the absolute value of the difference between a first wind pressure detected by the first wind pressure sensor and a second wind pressure detected by the second wind pressure sensor, and wherein the control unit controls the image of the display unit to be scrolled when the absolute value is equal to or more than a first threshold value, and controls a selection item displayed on the display unit to be selected when the absolute value is less than the first threshold value.

(4) The information processing apparatus according to (3), wherein the control unit controls the image of the display unit to be scrolled in a direction from the first wind pressure sensor to the second wind pressure sensor when the absolute value is equal to or more than the first threshold value and the first wind pressure is higher than the second wind pressure, and wherein the control unit controls the image of the display unit to be scrolled in a direction from the second wind pressure sensor to the first wind pressure sensor when the absolute value is equal to or more than the first threshold value and the first wind pressure is lower than the second wind pressure.

(5) The information processing apparatus according to (3) or (4), wherein the control unit changes at least one of the movement amount and the speed of scrolling according to at least one of the first wind pressure and the second wind pressure.

(6) The information processing apparatus according to any one of (3) to (5), wherein the control unit divides a screen of the display unit into a plurality of parts in the direction from the first wind pressure sensor to the second wind pressure sensor, and controls the selection item of the division closer to higher one of the first wind pressure and the second wind pressure to be selected when the absolute value is less than the first threshold value and equal to or more than a second threshold value.

(7) The information processing apparatus according to (6), wherein the control unit controls the selection item of the intermediate division between the first wind pressure sensor and the second wind pressure sensor to be selected when the absolute value is less than the first threshold value and less than the second threshold value.

(8) The information processing apparatus according to any one of (3) to (7), wherein the first wind pressure sensor is provided at an upper portion of the display unit, and wherein the second wind pressure sensor is provided at a lower portion of the display unit.

(9) The information processing apparatus according to any one of (3) to (7), wherein the first wind pressure sensor is provided at a left portion of the display unit, and wherein the second wind pressure sensor is provided at a right portion of the display unit.

(10) The information processing apparatus according to any one of (2) to (9), wherein the calculation unit calculates the magnitude of the wind pressure or the absolute value of a difference in time.

(11) The information processing apparatus according to (2), wherein the plurality of wind pressure sensors are provided at an upper portion, a lower portion, a left portion, and a right portion of the display device, wherein the calculation unit calculates the absolute value of the difference between an upper wind pressure detected by an upper wind pressure sensor and a lower wind pressure detected by a lower wind pressure sensor, and calculates the absolute value of the difference between a left wind pressure detected by a left wind pressure sensor and a right wind pressure detected by a right wind pressure sensor, wherein the control unit controls the image of the display unit to be scrolled when the absolute value of the difference between the upper wind pressure and the lower wind pressure is equal to or more than a first threshold value or when the absolute value of the difference between the left wind pressure and the right wind pressure is equal to or more than a second threshold value, and wherein the control unit controls a selection item displayed on the display unit to be selected when the absolute value of the difference between the upper wind pressure and the lower wind pressure is less than the first threshold value and when the absolute value of the difference between the left wind pressure and the right wind pressure is less than the second threshold value.

(12) The information processing apparatus according to (11), wherein the control unit controls the image of the display unit to be scrolled in a downward right direction when the absolute value of the difference between the upper wind pressure and the lower wind pressure is equal to or more than the first threshold value, when the upper wind pressure is higher than the lower wind pressure, when the absolute value of the difference between the left wind pressure and the right wind pressure is equal to or more than the second threshold value, and when the left wind pressure is higher than the right wind pressure, wherein the control unit controls the image of the display unit to be scrolled in a downward left direction when the absolute value of the difference between the upper wind pressure and the lower wind pressure is equal to or more than the first threshold value, when the upper wind pressure is higher than the lower wind pressure, when the absolute value of the difference between the left wind pressure and the right wind pressure is equal to or more than the second threshold value, and when the left wind pressure is lower than the right wind pressure, wherein the control unit controls the image of the display unit to be scrolled in a downward direction when the absolute value of the difference between the upper wind pressure and the lower wind pressure is equal to or more than the first threshold value, when the upper wind pressure is higher than the lower wind pressure, and when the absolute value of the difference between the left wind pressure and the right wind pressure is less than the second threshold value, wherein the control unit controls the image of the display unit to be scrolled in an upward right direction when the absolute value of the difference between the upper wind pressure and the lower wind pressure is equal to or more than the first threshold value, when the upper wind pressure is lower than the lower wind pressure, when the absolute value of the difference between the left wind pressure and the right wind pressure is equal to or more than the second threshold value, and when the left wind pressure is higher than the right wind pressure, wherein the control unit controls the image of the display unit to be scrolled in an upward left direction when the absolute value of the difference between the upper wind pressure and the lower wind pressure is equal to or more than the first threshold value, when the upper wind pressure is lower than the lower wind pressure, when the absolute value of the difference between the left wind pressure and the right wind pressure is equal to or more than the second threshold value, and when the left wind pressure is lower than the right wind pressure, wherein the control unit controls the image of the display unit to be scrolled in an upward direction when the absolute value of the difference between the upper wind pressure and the lower wind pressure is equal to or more than the first threshold value, when the upper wind pressure is lower than the lower wind pressure, and when the absolute value of the difference between the left wind pressure and the right wind pressure is less than the second threshold value, wherein the control unit controls the image of the display unit to be scrolled in a rightward direction when the absolute value of the difference between the upper wind pressure and the lower wind pressure is less than the first threshold value, when the absolute value of the difference between the left wind pressure and the right wind pressure is equal to or more than the second threshold value, and when the left wind pressure is higher than the right wind pressure, and wherein the control unit controls the image of the display unit to be scrolled in a leftward direction when the absolute value of the difference between the upper wind pressure and the lower wind pressure is less than the first threshold value, when the absolute value of the difference between the left wind pressure and the right wind pressure is equal to or more than the second threshold value, and when the left wind pressure is lower than the right wind pressure.

(13) The information processing apparatus according to (11) or (12), wherein the control unit changes at least one of the movement amount and the speed of scrolling according to at least one of the upper wind pressure, the lower wind pressure, the left wind pressure, and the right wind pressure.

(14) The information processing apparatus according to any one of (11) to (13), wherein the control unit divides the screen of the display unit into a plurality of parts in the up and down direction and the left and rightward direction, and controls the selection item of the division closer to higher one of the upper wind pressure and the lower wind pressure and closer to higher one of the left wind pressure and the right wind pressure to be selected when the absolute value of the difference between the upper wind pressure and the lower wind pressure is less than the first threshold value and equal to or more than a third threshold value and when the absolute value of the difference between the left wind pressure and the right wind pressure is less than the second threshold value and equal to or more than a fourth threshold value.

(15) The information processing apparatus according to (14), wherein the control unit controls the selection item of the intermediate division between the upper wind pressure sensor and the lower wind pressure sensor to be selected when the absolute value of the difference between upper wind pressure and the lower wind pressure is less than the first threshold value and less than the third threshold value and when the absolute value of the difference between the left wind pressure and the right wind pressure is less than the second threshold value.

(16) The information processing apparatus according to (14) or (15), wherein the control unit controls the selection item of the intermediate division between the left wind pressure sensor and the right wind pressure sensor to be selected when the absolute value of the difference between the upper wind pressure and the lower wind pressure is less than the first threshold value and when the absolute value of the difference between the left wind pressure and the right wind pressure is less than the second threshold value and less than the fourth threshold value.

The present disclosure contains subject matter related to that disclosed in Japanese Priority Patent Application JP 2011-062729 filed in the Japan Patent Office on Mar. 22, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a plurality of wind pressure sensors that detect wind pressures; and
a control unit that controls a predetermined process to be performed according to difference of the wind pressures detected by the plurality of wind pressure sensors.

2. The information processing apparatus according to claim 1, further comprising:
a display unit that displays an image; and
a calculation unit that calculates an absolute value of the difference of the wind pressures detected by the plurality of wind pressure sensors,
wherein the control unit performs the predetermined process on the image displayed on the display unit on the basis of the absolute value calculated by the calculation unit.

3. The information processing apparatus according to claim 2, wherein the plurality of wind pressure sensors include a first wind pressure sensor and a second wind pressure sensor provided at predetermined positions around the display unit,
wherein the calculation unit calculates the absolute value of the difference between a first wind pressure detected by the first wind pressure sensor and a second wind pressure detected by the second wind pressure sensor, and
wherein the control unit controls the image of the display unit to be scrolled when the absolute value is equal to or more than a first threshold value, and controls a selection item displayed on the display unit to be selected when the absolute value is less than the first threshold value.

4. The information processing apparatus according to claim 3, wherein the control unit controls the image of the display unit to be scrolled in a direction from the first wind pressure sensor to the second wind pressure sensor when the absolute value is equal to or more than the first threshold value and the first wind pressure is higher than the second wind pressure, and
wherein the control unit controls the image of the display unit to be scrolled in a direction from the second wind pressure sensor to the first wind pressure sensor when the absolute value is equal to or more than the first threshold value and the first wind pressure is lower than the second wind pressure.

5. The information processing apparatus according to claim 4, wherein the control unit changes at least one of a movement amount and speed of scrolling according to at least one of the first wind pressure and the second wind pressure.

6. The information processing apparatus according to claim 5, wherein the control unit divides a screen of the display unit into a plurality of parts in the direction from the first wind pressure sensor to the second wind pressure sensor, and controls the selection item of the division closer to the higher of the first wind pressure and the second wind pressure to be selected when the absolute value is less than the first threshold value and equal to or more than a second threshold value.

7. The information processing apparatus according to claim 6, wherein the control unit controls the selection item of the intermediate division between the first wind pressure sensor and the second wind pressure sensor to be selected when the absolute value is less than the first threshold value and less than the second threshold value.

8. The information processing apparatus according to claim 7, wherein the first wind pressure sensor is provided at an upper portion of the display unit, and
wherein the second wind pressure sensor is provided at a lower portion of the display unit.

9. The information processing apparatus according to claim 7, wherein the first wind pressure sensor is provided at a left portion of the display unit, and
wherein the second wind pressure sensor is provided at a right portion of the display unit.

10. The information processing apparatus according to claim 8, wherein the calculation unit calculates magnitude of the wind pressure or an absolute value of a difference in time.

11. The information processing apparatus according to claim 2, wherein the plurality of wind pressure sensors are provided at an upper portion, a lower portion, a left portion, and a right portion of the display device,
wherein the calculation unit calculates an absolute value of the difference between an upper wind pressure detected by an upper wind pressure sensor and a lower wind pressure detected by a lower wind pressure sensor, and calculates an absolute value of the difference between a left wind pressure detected by a left wind pressure sensor and a right wind pressure detected by a right wind pressure sensor,
wherein the control unit controls the image of the display unit to be scrolled when the absolute value of the difference between the upper wind pressure and the lower wind pressure is equal to or more than a first threshold value or when the absolute value of the difference between the left wind pressure and the right wind pressure is equal to or more than a second threshold value, and
wherein the control unit controls a selection item displayed on the display unit to be selected when the absolute value of the difference between the upper wind pressure and the lower wind pressure is less than the first threshold value and when the absolute value of the difference between the left wind pressure and the right wind pressure is less than the second threshold value.

12. The information processing apparatus according to claim 11, wherein the control unit controls the image of the display unit to be scrolled in a downward right direction when the absolute value of the difference between the upper wind pressure and the lower wind pressure is equal to or more than the first threshold value, when the upper wind pressure is higher than the lower wind pressure, when the absolute value of the difference between the left wind pressure and the right wind pressure is equal to or more than the second threshold value, and when the left wind pressure is higher than the right wind pressure,
wherein the control unit controls the image of the display unit to be scrolled in a downward left direction when the absolute value of the difference between the upper wind pressure and the lower wind pressure is equal to or more than the first threshold value, when the upper wind pressure is higher than the lower wind pressure, when the absolute value of the difference between the left wind pressure and the right wind pressure is equal to or more than the second threshold value, and when the left wind pressure is lower than the right wind pressure,
wherein the control unit controls the image of the display unit to be scrolled in a downward direction when the absolute value of the difference between the upper wind pressure and the lower wind pressure is equal to or more than the first threshold value, when the upper wind pressure is higher than the lower wind pressure, and when the absolute value of the difference between the left wind pressure and the right wind pressure is less than the second threshold value,
wherein the control unit controls the image of the display unit to be scrolled in an upward right direction when the absolute value of the difference between the upper wind pressure and the lower wind pressure is equal to or more than the first threshold value, when the upper wind pressure is lower than the lower wind pressure, when the absolute value of the difference between the left wind pressure and the right wind pressure is equal to or more than the second threshold value, and when the left wind pressure is higher than the right wind pressure,
wherein the control unit controls the image of the display unit to be scrolled in an upward left direction when the absolute value of the difference between the upper wind pressure and the lower wind pressure is equal to or more than the first threshold value, when the upper wind pressure is lower than the lower wind pressure, when the absolute value of the difference between the left wind pressure and the right wind pressure is equal to or more than the second threshold value, and when the left wind pressure is lower than the right wind pressure,
wherein the control unit controls the image of the display unit to be scrolled in an upward direction when the absolute value of the difference between the upper wind pressure and the lower wind pressure is equal to or more than the first threshold value, when the upper wind pressure is lower than the lower wind pressure, and when the absolute value of the difference between the left wind pressure and the right wind pressure is less than the second threshold value,
wherein the control unit controls the image of the display unit to be scrolled in a rightward direction when the absolute value of the difference between the upper wind pressure and the lower wind pressure is less than the first threshold value, when the absolute value of the difference between the left wind pressure and the right wind pressure is equal to or more than the second threshold value, and when the left wind pressure is higher than the right wind pressure, and
wherein the control unit controls the image of the display unit to be scrolled in a leftward direction when the absolute value of the difference between the upper wind pressure and the lower wind pressure is less than the first threshold value, when the absolute value of the difference between the left wind pressure and the right wind pressure is equal to or more than the second threshold value, and when the left wind pressure is lower than the right wind pressure.

13. The information processing apparatus according to claim 12, wherein the control unit changes at least one of the movement amount and the speed of scrolling according to at least one of the upper wind pressure, the lower wind pressure, the left wind pressure, and the right wind pressure.

14. The information processing apparatus according to claim 13, wherein the control unit divides the screen of the display unit into a plurality of parts in an up and down direction and a left and rightward direction, and controls the selection item of the division closer to higher one of the upper wind pressure and the lower wind pressure and closer to higher one of the left wind pressure and the right wind pressure to be selected when the absolute value of the difference between the upper wind pressure and the lower wind pressure is less than the first threshold value and equal to or more than a third threshold value and when the absolute value of the difference between the left wind pressure and the right wind pressure is less than the second threshold value and equal to or more than a fourth threshold value.

15. The information processing apparatus according to claim 14, wherein the control unit controls the selection item of the intermediate division between the upper wind pressure sensor and the lower wind pressure sensor to be selected when the absolute value of the difference between upper wind pressure and the lower wind pressure is less than the first threshold value and less than the third threshold value and when the absolute value of the difference between the left wind pressure and the right wind pressure is less than the second threshold value.

16. The information processing apparatus according to claim 15, wherein the control unit controls the selection item of the intermediate division between the left wind pressure sensor and the right wind pressure sensor to be selected when the absolute value of the difference between the upper wind pressure and the lower wind pressure is less than the first threshold value and when the absolute value of the difference between the left wind pressure and the right wind pressure is less than the second threshold value and less than the fourth threshold value.

17. An information processing method of an information processing apparatus provided with a plurality of wind pressure sensors that detect wind pressures, the method comprising:
controlling a predetermined process to be performed according to difference of wind pressures detected by the plurality of wind pressure sensors.

18. A computer readable recording medium of recording a program for causing a computer controlling an information processing apparatus provided with a plurality of wind pressure sensors detecting wind pressures to execute:
controlling a predetermined process to be performed according to difference of wind pressures detected by the plurality of wind pressure sensors.

19. A program for causing a computer controlling an information processing apparatus provided with a plurality of wind pressure sensors detecting wind pressures to execute:
controlling a predetermined process to be performed according to difference of wind pressures detected by the plurality of wind pressure sensors.
